(19) United States
(12) Patent Application Publication
(10) Pub. No.: US 2023/0272893 A1
(43) Pub. Date: Aug. 31, 2023

(54) INTEGRATED LiDAR WITH SCANNING PHOSPHOR ILLUMINATION SYSTEM AND METHOD

(71) Applicant: Optonomous Technologies, Inc., Agoura Hills, CA (US)

(72) Inventors: Kenneth Li, Agoura Hills, CA (US); Yung Peng Chang, Hsinchu (TW); Lion Wang, Hsinchu (TW); Andy Chen, Taichung (TW); Kirk Huang, Taichung (TW); Stark Tsai, Hsinchu (TW)

(21) Appl. No.: 18/014,138

(22) PCT Filed: Jun. 25, 2021
(86) PCT No.: PCT/US2021/039266

§ 371 Date: Dec. 30, 2022

Related U.S. Application Data
(60) Provisional application No. 63/136,312, filed on Jan. 12, 2021.
(60) Provisional application No. 63/047,905, filed on Jul. 2, 2020.

(51) Int. Cl. F21S 41/16; G03B 21/28; G03B 21/20; G03B 21/16; B60Q 1/00; G01S 7/481; F21S 41/13; F21S 41/25; G01S 17/06

(52) U.S. Cl. CPC F21S 41/16; G03B 21/28; G03B 21/2033; G03B 21/16; B60Q 1/0023; G01S 7/4817; G01S 7/4814; F21S 41/13; F21S 41/25; G01S 17/06

(57) ABSTRACT

A scanning beam system using a rotating platform driven by a motor, and a prism and/or mirror assembly mounted to the rotating platform. In some embodiments, the prism is a square prism. In some embodiments the prism is of polygon shape other than a square. In some embodiments, the mirror assembly is a square mirror assembly. In some embodiments the mirror assembly is of polygon shape other than a square. In some embodiments the mirror assembly includes a plurality of reflective faces, each at a different angle relative to an axis of rotation of the rotating platform.

### CROSS-REFERENCE TO RELATED APPLICATIONS

This application claims priority benefit, including under 35 U.S.C. § 119(e), of
U.S. Provisional Patent Application 63/047,905 titled “Scanning phosphor illumination system and method,” filed Jul. 2, 2020, by Kenneth Li et al.; and
U.S. Provisional Patent Application 63/136,312 titled “Scanning phosphor illumination system,” filed Jan. 12, 2021 by Kenneth Li; each of which is incorporated herein by reference in its entirety.

This application is related to:
U.S. Provisional Patent Application 62/916,580 titled “Recycling Light System using Total Internal Reflection to Increase Brightness of a Light Source,” filed Oct. 17, 2019, by Kenneth Li;
U.S. Provisional Patent Application 62/763,423 titled “Laser Excited Crystal Phosphor Light Module,” filed Jun. 14, 2018 by Yung Peng Chang et al.,
U.S. Provisional Patent Application 62/764,085 titled “Laser Excited Crystal Phosphor Light Source with Side Excitation,” filed Jul. 18, 2018 by Yung Peng Chang et al.,
U.S. Provisional Patent Application 62/764,090 titled “Laser Excited RGB Crystal Phosphor Light Source,” filed Jul. 18, 2018 by Yung Peng Chang et al.,
U.S. Provisional Patent Application 62/766,209 titled “Laser Phosphor Light Source for Intelligent Headlights and Spotlights,” filed Oct. 5, 2018 by Yung Peng Chang et al.,
P.C.T. Patent Application No. PCT/US2020/037669, titled “HYBRID LED/LASER LIGHT SOURCE FOR SMART HEADLIGHT APPLICATIONS,” filed Jun. 14, 2020 by Kenneth Li et al. (published Dec. 24, 2020 as WO 2020/257091),
U.S. Provisional Patent Application 62/862,549 titled “ENHANCEMENT OF LED INTENSITY PROFILE USING LASER EXCITATION,” filed Jun. 17, 2019, by Kenneth Li;
U.S. Provisional Patent Application 62/874,943 titled “ENHANCEMENT OF LED INTENSITY PROFILE USING LASER EXCITATION,” filed Jul. 16, 2019, by Kenneth Li;
U.S. Provisional Patent Application 62/938,863 titled “DUAL LIGHT SOURCE FOR SMART HEADLIGHT APPLICATIONS,” filed Nov. 21, 2019, by Y. P. Chang et al.;
U.S. Provisional Patent Application 62/954,337 titled “HYBRID LED/LASER LIGHT SOURCE FOR SMART HEADLIGHT APPLICATIONS,” filed Dec. 27, 2019, by Kenneth Li;
P.C.T. Patent Application No. PCT/US2020/034447, filed May 24, 2020 by Y. P. Chang et al., titled “LiDAR INTEGRATED WITH SMART HEADLIGHT AND METHOD” (published Dec. 3, 2020 as WO 2020/243038);
U.S. Provisional Patent Application No. 62/853,538, filed May 28, 2019 by Y. P. Chang et al., titled “LIDAR Integrated With Smart Headlight Using a Single DMD”;
U.S. Provisional Patent Application No. 62/857,662, filed Jun. 5, 2019 by Chun-Nien Liu et al., titled “Scheme of LIDAR-Embedded Smart Laser Headlight for Autonomous Driving”;
U.S. Provisional Patent Application No. 62/950,080, filed Dec. 18, 2019 by Kenneth Li, titled “Integrated LIDAR and Smart Headlight using a Single MEMS Mirror”;
PCT Patent Application PCT/US2019/037231 titled “ILLUMINATION SYSTEM WITH HIGH INTENSITY OUTPUT MECHANISM AND METHOD OF OPERATION THEREOF,” filed Jun. 14, 2019, by Y. P. Chang et al. (published Jan. 16, 2020 as WO 2020/013952);
U.S. patent application Ser. No. 16/509,085 titled “ILLUMINATION SYSTEM WITH CRYSTAL PHOSPHOR MECHANISM AND METHOD OF OPERATION THEREOF,” filed Jul. 11, 2019, by Y. P. Chang et al. (published Jan. 23, 2020 as US 2020/0026169);
U.S. patent application Ser. No. 16/509,196 titled “ILLUMINATION SYSTEM WITH HIGH INTENSITY PROJECTION MECHANISM AND METHOD OF OPERATION THEREOF,” filed Jul. 11, 2019, by Y. P. Chang et al. (issued Aug. 25, 2020 as U.S. Pat. No. 10,754,236);
U.S. Provisional Patent Application 62/837,077 titled “LASER EXCITED CRYSTAL PHOSPHOR SPHERE LIGHT SOURCE,” filed Apr. 22, 2019, by Kenneth Li et al.;
U.S. Provisional Patent Application 62/853,538 titled “LIDAR INTEGRATED WITH SMART HEADLIGHT USING A SINGLE DMD,” filed May 28, 2019, by Y. P. Chang et al.;
U.S. Provisional Patent Application 62/856,518 titled “VERTICAL CAVITY SURFACE EMITTING LASER USING DICHROIC REFLECTORS,” filed Jul. 8, 2019, by Kenneth Li et al.;
U.S. Provisional Patent Application 62/871,498 titled “LASER-EXCITED PHOSPHOR LIGHT SOURCE AND METHOD WITH LIGHT RECYCLING,” filed Jul. 8, 2019, by Kenneth Li;
U.S. Provisional Patent Application 62/857,662 titled “SCHEME OF LIDAR-EMBEDDED SMART LASER HEADLIGHT FOR AUTONOMOUS DRIVING,” filed Jun. 5, 2019, by Chun-Nien Liu et al.;
U.S. Provisional Patent Application 62/873,171 titled “SPECKLE REDUCTION USING MOVING MIRRORS AND RETRO-REFLECTORS,” filed Jul. 11, 2019, by Kenneth Li;
U.S. Provisional Patent Application 62/881,927 titled “SYSTEM AND METHOD TO INCREASE BRIGHTNESS OF DIFFUSED LIGHT WITH FOCUSED RECYCLING,” filed Aug. 1, 2019, by Kenneth Li;
U.S. Provisional Patent Application 62/895,367 titled “INCREASED BRIGHTNESS OF DIFFUSED LIGHT WITH FOCUSED RECYCLING,” filed Sep. 3, 2019, by Kenneth Li;
U.S. Provisional Patent Application 62/903,620 titled “RGB LASER LIGHT SOURCE FOR PROJECTION DISPLAYS,” filed Sep. 20, 2019, by Lion Wang et al.; and
PCT Patent Application No. PCT/US2020/035492, filed Jun. 1, 2020 by Kenneth Li et al., titled “VERTICAL-CAVITY SURFACE-EMITTING LASER USING DICHROIC REFLECTORS” (published Dec. 13, 2020 as WO 22020/247291); each of which is incorporated herein by reference in its entirety.

U.S. Pat. No. 8,979,308 issued to Kenneth Li on Mar. 17, 2015 with the title “LED illumination system with recycled light”, and is incorporated herein by reference. U.S. Pat. No. 8,979,308 describes an LED illumination system includes at least one LED element and a recycling reflector having a transmissive aperture through which emitted light passes. The recycling reflector has a curved surface adapted to reflect the impinging light back to the LED element for improved light output through the transmissive aperture.

U.S. Pat. No. 8,858,037 issued to Kenneth Li on Oct. 14, 2014 with the title “Light emitting diode array illumination system with recycling”, and is incorporated herein by reference. U.S. Pat. No. 8,858,037 describes an LED illumination system includes a plurality of LED modules and a plurality of corresponding collimating lenses to provide increased brightness. Each LED module has at least one LED chip having a light emitting area that emits light and a recycling reflector. The reflector is positioned to reflect the light from the light emitting area back to the LED chip and has a transmissive aperture through which the emitted light exits. The collimating lenses are arranged to receive and collimate the light exiting from the LED modules.

U.S. Pat. No. 8,602,567 issued to Ouyang et al. on Dec. 10, 2013 with the title “Multiplexing light pipe having enhanced brightness”, and is incorporated herein by reference. U.S. Pat. No. 8,602,567 describes multi-color light sources mixed in a recycling housing to achieve high light output. Light from each color light source is multiplexed and a portion of the mixed light passes through an output aperture in the light pipe and a portion light is recycled back, for example, by a shaped reflective surface and/or a reflective coating adjacent the aperture. In one embodiment, the light is directed back from the output side of the housing to an input light source having the same color. In another embodiment, the light is directed back from the output side of the housing to a coating designed to reflect that color. The reflected light is then reflected back toward the output aperture and a portion of that reflected light is again reflected toward the input and impacts the original source for that color light.

U.S. Pat. No. 8,388,190 issued to Kenneth Li, et al. on Mar. 5, 2013 with the title “Illumination system and method for recycling light to increase the brightness of the light source”, and is incorporated herein by reference. U.S. Pat. No. 8,388,190 describes an illumination system for increasing the brightness of a light source that includes an optical recycling device coupled to the light source, preferably light emitting diode (LED), for spatially and/or angularly recycling light. The optical recycling device spatially recycles a portion of rays of light emitted by the LED back to the light source using a reflector or mirror and/or angularly recycles high angle rays of light and transmits small angle rays of light, thereby increasing the brightness of the light source's output.

U.S. Pat. No. 8,317,331 issued to Li on Nov. 27, 2012 with the title “Recycling system and method for increasing brightness using light pipes with one or more light sources, and a projector incorporating the same”, and is incorporated herein by reference. U.S. Pat. No. 8,317,331 describes a recycling system and method for increasing the brightness of light output using at least one recycling light pipe with at least one light source. The output end of the recycling light pipe reflects a first portion of the light back to the light source, a second portion the light to the input end of the recycling light pipe, and transmits the remaining portion of the light as output. The recycling system is incorporated into a projector to provide color projected image with increased brightness. The light source can be white LEDs, color LEDs, and dual paraboloid reflector (DPR) lamp.

U.S. Pat. No. 7,976,204 issued to Kenneth Li et al. Jul. 12, 2011 with the title “Illumination system and method for recycling light to increase the brightness of the light source”, and is incorporated herein by reference. U.S. Pat. No. 7,976,204 describes an illumination system for increasing the brightness of a light source comprises an optical recycling device coupled to the light source, preferably light emitting diode (LED), for spatially and/or angularly recycling light. The optical recycling device spatially recycles a portion of rays of light emitted by the LED back to the light source using a reflector or mirror and/or angularly recycles high angle rays of light and transmits small angle rays of light, thereby increasing the brightness of the light source's output.

U.S. Pat. No. 7,710,669 issued to Kenneth Li on May 4, 2010 with the title “Etendue efficient combination of multiple light sources”, and is incorporated herein by reference. U.S. Pat. No. 7,710,669 describes a multi-colored illumination system including a beam combiner. The beam combiner includes two triangular prisms and a filter for transmitting a first light and reflecting a second light, each light having a different wavelength. The beam combiner combines the transmitted first light and the reflected light to provide a combined beam. The six surfaces of each of the triangular prism of the beam combiner are polished, thereby combining the lights without increasing etendue of the multi-colored illumination system.

U.S. Pat. No. 7,232,228 issued to Kenneth Li on Jun. 19, 2007 with the title “Light recovery for projection displays”, and is incorporated herein by reference. U.S. Pat. No. 7,232,228 describes a light-recovery system for a projection display with a reflector having a first and a second focal points. A source of electro-magnetic radiation is disposed proximate to the first focal point of the reflector to emit rays of radiation that reflect from the reflector and converge substantially at the second focal point. A retro-reflector reflects at least a portion of the electromagnetic radiation that does not impinge directly on the reflector toward the reflector through the first focal point of the reflector to increase the flux intensity of the converging rays.

### FIELD OF THE INVENTION

This invention relates to the field of light sources and/or receivers, and more specifically to a method and light-manipulation system that includes a controller that controls one or more scanned light beams and, optionally, a wavelength-converting phosphor plate, wherein the light-manipulation system includes a light source and a rotating faceted optical element that together are usable as an adaptive-driving-beam (ADB) headlight system that generates a selectively controlled ADB headlight output pattern, and optionally includes a LiDAR (“light detection and ranging” or “laser imaging, detection, and ranging”) output-signal generator that selectively controls successive output directions of a LiDAR output signal, and a LiDAR receiver that selectively receives return signal from primarily those successive directions corresponding to the successive output directions of the LiDAR output signal. In some embodiments, the ADB headlight system includes a single rotary motor that synchronously rotates three optical elements: a first polygonal mirror system that scans the light for the headlight output pattern, a second polygonal mirror system that scans the successive output directions of the LiDAR output signal, and a third polygonal mirror system that scans the successive input directions for the LiDAR return signal.

### BACKGROUND OF THE INVENTION

In various automotive adaptive-driving-beam (ADB) systems, the modulation of the output headlight-beam pattern can be achieved by using an imaging device, e.g., a DMD (digital micromirror device), or a scanned laser beam exciting a spot moving across a phosphor plate for wavelength-converted emission of a scanned visible spot that is scanned using various means, such as one or more MEMS (micro-electromechanical systems) mirrors, or rotating mirrors. When the scanning visible spot from the phosphor plate is projected by lenses and/or mirrors onto the roadway, various scanned light-output patterns can be obtained by modulating the drive current of the laser. For various scanning systems, a rotating optical element is the preferred method, because reliable motors are readily available and have been well proven in many applications, including beam scanners, projector color wheels, phosphor wheels, etc.

What is needed is an improved system for a selectively changeable variable-pattern automotive headlight and optionally integrated with a LiDAR system for assisted and/or autonomous vehicles.

### SUMMARY OF THE INVENTION

In some embodiments, the present invention includes a scanning beam system that uses a rotating platform driven by a motor, and a prism or mirror array—in some embodiments, a simple square prism and/or mirrors to scan a laser beam across an area such as a phosphor plate, along with optional optics to project the resulting light pattern. The invention allows laser excitation of such a phosphor plate to move across widespread areas of the phosphor plate, in a manner that prevents overheating of the phosphor plate in any specific location. In some embodiments, the phosphor plate surface is curved such that a scanned beam from a rotating optical beam deflector (such as a prism or polygonal mirror system) remains in focus across the surface of the phosphor plate. In some embodiments, the system includes a LiDAR system sharing part of the scanning mechanism of the lighting system.

In some embodiments, the present invention provides a first method for scanning a light beam. This first method includes: providing a first faceted optical device; rotating the first faceted optical device around a rotational axis; wherein the first faceted optical device has a plurality of faces, each of which is at one selected angle of a plurality of different angles relative to the rotational axis; generating a first light beam; and deflecting the first light beam toward the rotating first faceted optical device to form a first plurality of spaced-apart scanned light-beam lines. In some embodiments, the deflecting includes refracting the first light beam using a transparent prism. In other embodiments, the deflecting includes refracting the first light beam using a plurality of mirrors on the rotated first faceted optical device.

In some embodiments, the present invention provides first system having a scanned-light-beam apparatus that includes: a first source of a first light beam; a first rotary motor that has a rotational axis; and a first faceted optical device that is rotated around the rotational axis by the first motor, wherein the first faceted optical device has a plurality of faces, each of which is at one selected angle of a plurality of different angles relative to the rotational axis, and wherein the first light beam is operatively coupled to the rotated first faceted optical device to form a first plurality of spaced-apart scanned light-beam lines.

### BRIEF DESCRIPTION OF THE DRAWINGS

FIG. 1A is a perspective view of a square transparent prism system 101, according to some embodiments of the present invention.

FIG. 1B is a top view of square transparent prism system 101 with a square-top rectangular rotating prism 110 in a first orientation relative to input beam 140, according to some embodiments of the present invention.

FIG. 1C is a top view of square transparent prism system 101 with rotating prism 110 in a second orientation (indicated as 110′) relative to input beam 140.

FIG. 1D is a top view of square transparent prism system 101 with rotating prism 110 in a third orientation (indicated as 110″) relative to input beam 140.

FIG. 1E is a top view of square transparent prism system 101 with rotating prism 110 in a fourth orientation (indicated as 110′″) relative to input beam 140.

FIG. 2 is a top view of a square transparent prism system 201 with rotating prism 110 in three different orientations (indicated as 110, 110′, 110″) relative to input beam 140, and a transparent phosphor plate 240, according to some embodiments of the present invention.

FIG. 3A is a top view of a square transparent prism system 301 with rotating prism 110 in three different orientations (indicated as 110, 110′, 110″) relative to input beam 140, and a reflective phosphor plate 340, according to some embodiments of the present invention.

FIG. 3B is a side view of one embodiment of square transparent prism system 301 with rotating prism 110 in the third orientations (indicated 110″) relative to a horizontal input beam 140, according to some embodiments of the present invention.

FIG. 3C is a side view of an alternative square transparent prism system 303 (which would have a top view substantially similar to FIG. 3A) with rotating prism 110 in the third orientations (indicated 110″) relative to tilted-to-horizontal input beam 140, according to some embodiments of the present invention.

FIG. 4A is a top view of a rotating-transparent-prism system 401 with a rotating square-top angle-sided transparent prism 410 in a first orientation (indicated as 410, in contrast to the orientation 410′ shown in FIGS. 5A-5D) relative to first input beam 440 and second input beam 445 (which are vertically above one another as shown in FIG. 4B, FIG. 4C and FIG. 4D, but here are shown superimposed due to the view), according to some embodiments of the present invention.

FIG. 4B is a left-side-elevation view of rotating-transparent-prism system 401 with rotating square-top angle-sided transparent prism 410 in the first orientation (indicated as 410) relative to first input beam 440 and second input beam 445.

FIG. 4C is a front-side-elevation view of rotating-transparent-prism system 401 with rotating square-top angle-sided transparent prism 410 in the first orientation (indicated as 410) relative to first input beam 440 and second input beam 445.

FIG. 4D is a right-side-elevation view of rotating-transparent-prism system 401 with rotating square-top angle-sided transparent prism 410 in the first orientation (indicated as 410) relative to first output beam 441 and second output beam 446.

FIG. 5A is a top view of rotating-transparent-prism system 401 with a rotating square-top angle-sided transparent prism 410 in a second orientation (indicated as 410′, which is rotated around the center rotational axis 430 about twenty-three degrees (23°) relative to the view of FIG. 4A) relative to first input beam 440 and second input beam 445 (which are vertically above one another as shown in FIG. 5B, FIG. 5C and FIG. 5D, but here are shown superimposed due to the view), according to some embodiments of the present invention.

FIG. 5B is a left-side-elevation view of rotating-transparent-prism system 401 with rotating square-top angle-sided transparent prism 410 in the second orientation (indicated as 410′) relative to first input beam 440 and second input beam 445.

FIG. 5C is a front-side-elevation view of rotating-transparent-prism system 401 with rotating square-top angle-sided transparent prism 410 in the second orientation (indicated as 410′) relative to first input beam 440 and second input beam 445 and relative to first exit beam 441′ and second input beam 446′.

FIG. 5D is a right-side-elevation view of rotating-transparent-prism system 401 with rotating square-top angle-sided transparent prism 410 in the second orientation (indicated as 410′) relative to first exit beam 441′ and second input beam 446′.

FIG. 6A is a top view of a rotating-transparent-prism system 601 with a rotating square-top angle-sided transparent prism 610 in a first orientation (indicated as 610, in contrast to the orientation 610′ shown in FIGS. 6E-6H) relative to first input beam 640 and first exit beam 641 having a first displacement, according to some embodiments of the present invention.

FIG. 6B is a left-side-elevation view of rotating-transparent-prism system 601 with rotating square-top angle-sided transparent prism 610 in the first orientation (indicated as 610) relative to first input beam 640 and exit beam 641 having the first displacement.

FIG. 6C is a front-side-elevation view of rotating-transparent-prism system 601 with rotating square-top angle-sided transparent prism 610 in the first orientation (indicated as 610) relative to first input beam 640 and exit beam 641 having the first displacement.

FIG. 6D is a right-side-elevation view of rotating-transparent-prism system 601 with rotating square-top angle-sided transparent prism 610 in the first orientation (indicated as 610) relative to first input beam 640 and exit beam 641 having the first displacement.

FIG. 6E is a top view of rotating-transparent-prism system 601 with rotating square-top angle-sided transparent prism 610 in a second orientation (indicated as 610′) relative to first input beam 640 and exit beam 641′ having a second displacement (see FIG. 8).

FIG. 6F is a left-side-elevation view of rotating-transparent-prism system 601 with rotating square-top angle-sided transparent prism 610 in the second orientation (indicated as 610′) relative to first input beam 640 and exit beam 641′ having the second displacement.

FIG. 6G is a front-side-elevation view of rotating-transparent-prism system 601 with rotating square-top angle-sided transparent prism 610 in the second orientation (indicated as 610′) relative to first input beam 640 and exit beam 641′ having the second displacement.

FIG. 6H is a right-side-elevation view of rotating-transparent-prism system 601 with rotating square-top angle-sided transparent prism 610 in the second orientation (indicated as 610′) relative to first input beam 640 and exit beam 641′ having the second displacement.

FIG. 7A is a top view of a rotating-transparent-prism system 601 with rotating square-top angle-sided transparent prism 610 in a third orientation (indicated as 610″) relative to first input beam 640 and exit beam 641″ having a third displacement (see FIG. 8), according to some embodiments of the present invention.

FIG. 7B is a left-side-elevation view of rotating-transparent-prism system 601 with rotating square-top angle-sided transparent prism 610 in the third orientation (indicated as 610″) relative to first input beam 640 and to first input beam 640 and exit beam 641″ having the third displacement.

FIG. 7C is a front-side-elevation view of rotating-transparent-prism system 601 with rotating square-top angle-sided transparent prism 610 in the third orientation (indicated as 610″) relative to first input beam 640 and exit beam 641″ having the third displacement.

FIG. 7D is a right-side-elevation view of rotating-transparent-prism system 601 with rotating square-top angle-sided transparent prism 610 in the third orientation (indicated as 610″) relative to first input beam 640 and exit beam 641″ having the third displacement.

FIG. 7E is a top view of rotating-transparent-prism system 601 with rotating square-top angle-sided transparent prism 610 in a fourth orientation (indicated as 610′″) relative to first input beam 640 and exit beam 641′″ having a fourth displacement (see FIG. 8).

FIG. 7F is a left-side-elevation view of rotating-transparent-prism system 601 with rotating square-top angle-sided transparent prism 610 in the fourth orientation (indicated as 610′″) relative to first input beam 640 and exit beam 641′″ having the fourth displacement.

FIG. 7G is a front-side-elevation view of rotating-transparent-prism system 601 with rotating square-top angle-sided transparent prism 610 in the fourth orientation (indicated as 610′″) relative to first input beam 640 and exit beam 641′″ having the fourth displacement.

FIG. 7H is a right-side-elevation view of rotating-transparent-prism system 601 with rotating square-top angle-sided transparent prism 610 in the fourth orientation (indicated as 610′″) relative to exit beam 641′″ having the fourth displacement.

FIG. 8 is a front-side-elevation view of rotating-transparent-prism system 601 with rotating square-top angle-sided transparent prism 610 in the four orientations (indicated as 610 as in FIG. 6C, 610′ as in FIG. 6G, 610″ as in FIG. 7C, and 610′″ as in FIG. 7G) relative to first input beam 640.

FIG. 9A is a top view of a top face 920 of a rotating-transparent-prism system 901 with rotating hexagonal-top rectangular-sided transparent prism 910 in a first orientation (indicated as 910) relative to first input beam 940, according to some embodiments of the present invention.

FIG. 9B is a top view of top face 920 of rotating-transparent-prism system 901 with rotating hexagonal-top rectangular-sided transparent prism 910 in a second orientation (indicated as 910′) relative to first input beam 940.

FIG. 9C is a top view of top face 920 of rotating-transparent-prism system 901 with rotating hexagonal-top rectangular-sided transparent prism 910 in a third orientation (indicated as 910″) relative to first input beam 940.

FIG. 10A is a top view of a rotating-transparent-prism system 1001 with rotating octagonal-top, rectangular-sided-faces transparent prism 1010 in a first orientation relative to first input beam 1040, according to some embodiments of the present invention.

FIG. 10B is a top view of a rotating-transparent-prism system 1002 with rotating ten-sided-top, rectangular-sided-faces transparent prism 1011 in a first orientation relative to first input beam 1040, according to some embodiments of the present invention.

FIG. 10C is a top view of a rotating-transparent-prism system 1003 with rotating twelve-sided-top, rectangular-sided-faces transparent prism 1013 in a first orientation relative to first input beam 1040, according to some embodiments of the present invention.

FIG. 11 is a front-elevational view of rotating-transparent-prism system 1101 with rotating square-top angle-sided transparent prism 1110, mounted on a wedge-spacer 1162 that is rotated by motor 1112, when in a first orientation relative to first input beam 1140, according to some embodiments of the present invention.

FIG. 12 is a perspective view of a spacer 1201 usable in rotating-transparent-prism system 1101, wherein spacer 1201 includes angular deviations in two directions, according to some embodiments of the present invention.

FIG. 13 is a top view of a spacer 1301 usable in rotating-transparent-prism system 1101, wherein spacer 1201 includes angular deviations in two directions such that the tilt axis 1335 does not correspond to axis 1331 or axis 1332 of a square prism, such as prism 1110 of FIG. 11, according to some embodiments of the present invention.

FIG. 14 is a top view of a spacer 1401 usable in rotating-transparent-prism system that uses an octagonal spacer 1410 and a prism such as octagonal prism 1310 of FIG. 10A, wherein spacer 1410 includes angular deviations in two directions such that the tilt axis 1435 does not correspond to any of the four axes of the octagonal prism such as 1010 of FIG. 10A, according to some embodiments of the present invention.

FIG. 15 is a top view of a rotating-transparent-prism system 1501 with a rotating square-top rectangular-sided transparent prism 1510 in a first orientation (indicated as 1510, in contrast to the orientation 1510′ shown in FIG. 16) relative to first input beam 1540 and second input beam 1545, each approaching different input faces (e.g., faces 1521 and 1522, respectively, in this first orientation), according to some embodiments of the present invention.

FIG. 16 is a top view of a rotating-transparent-prism system 1501 with a rotating square-top rectangular-sided transparent prism 1510 in a second orientation (indicated as 1510′) relative to first input beam 1540 and second input beam 1545.

FIG. 17 is a top view of a rotating-transparent-prism system 1701 with a rotating square-top rectangular-sided transparent prism 1510 in a second orientation (indicated as 1510′) relative to first input beam 1540 and second input beam 1545, and further including a flat mirror 1710, according to some embodiments of the present invention.

FIG. 18 is a front-elevational view of rotating-transparent-prism system 1801 with rotating square-top angle-sided transparent prism 1810, mounted on a wedge-spacer 1862 that is rotated by motor 1812, when in a first orientation relative to first input beam 1840 and second input beam 1845, both approaching the same input face (e.g., 1821 in this first orientation), according to some embodiments of the present invention.

FIG. 19 is a top view of a rotating-dual-mirror system 1901 that includes two semi-circular planar mirrors 1910 and 1920 mounted to or formed on a circular double-wedge-shaped substrate 1900, according to some embodiments of the present invention.

FIG. 20 is a perspective view of half of rotating-dual-mirror system 1901 (shown in its entirety in FIG. 21) showing semi-circular planar mirror 1910 mounted to or formed on double-wedge-shaped substrate 1900.

FIG. 21 is a perspective cross-section view of rotating-dual-mirror system 1901 that includes two semi-circular planar mirrors 1910 and 1920 mounted to or formed on a circular double-wedge-shaped substrate 1900.

FIG. 22A is a perspective cross-section view of wedged mirror 1910 of rotating-dual-mirror system 2201 in a first rotational orientation.

FIG. 22B is a perspective cross-section view of wedged mirror 1910 of rotating-dual-mirror system 2201 in a second rotational orientation.

FIG. 22A is a perspective cross-section view of wedged mirror 1910 of rotating-dual-mirror system 2201 in a third rotational orientation.

FIG. 23 is a top view of a rotating-triple-mirror system 2301 that includes three semi-circular planar mirrors 2310, 2320, and 2330 mounted to or formed on a circular triple-wedge-shaped substrate 2300, according to some embodiments of the present invention.

FIG. 24 is an elevational side view of a rotating circular double-wedged mirror system 2401 with rotating mirror 2411, mounted on a wedge-spacer 2410 that is rotated by motor 2412, when mirror 2411 is in a first orientation (indicated by 2411) and in a second orientation (indicated by 2411′) relative to first input beam 2440, according to some embodiments of the present invention.

FIG. 25A is a side view of a system 2501 that obeys the Scheimpflug principle, wherein the object plane 2531, the lens plane 2532 and the image plane 2533 (only the edges of which show in FIG. 25A) all intersect at a single line 2535 (only the end of which shows in FIG. 25A) to the right, according to some embodiments of the present invention.

FIG. 25B is a side view of a system 2502 that also obeys the Scheimpflug principle, according to some embodiments of the present invention.

FIG. 26 is a front-elevational side view of rotating-mirror system 2601 with rotating mirror 2411, mounted on a wedge-spacer 2410 that is rotated by motor 2412, when mirror 2411 is in a first orientation (indicated by 2411) and in a second orientation (indicated by 2411′) relative to first input beam 1140, according to some embodiments of the present invention.

FIG. 27A is a top view of a rotating octagonal-transparent-prism system 2701 with a rotating octagonal-top rectangular-sided transparent prism 2710 in a first orientation (indicated as 2710) and in a second orientation (indicated as 2710′) relative to first input beam 2740, and further including a rectangular beam-shifting prism 2770 and a mirror-prism-slotted mirror subsystem 2780, according to some embodiments of the present invention.

FIG. 27B a side view of rectangular beam-shifting prism 2770 of system 2701.

FIG. 28 is a top view of a mirror-prism-slotted-mirror and phosphor-plate system 2801, which adds phosphor plate 2880 to mirror-prism-slotted mirror subsystem 2780 (as shown in FIG. 27A), according to some embodiments of the present invention.

FIG. 29A a side view of an anamorphic-prism-pair system 2901 that can increase the width in one direction such that a greater number of lines with wider widths can be obtained simultaneously, according to some embodiments of the present invention.

FIG. 29B is a graph of magnification versus prism angels of anamorphic-prism-pair system 2901, according to some embodiments of the present invention.

FIG. 30 is a top view of a rotating octagonal-transparent-prism system 3001 with a rotating octagonal-top rectangular-sided transparent prism 3010 in a first orientation (solid-line outline) and a second orientation 3010′ (the slightly angularly offset dashed-line outline) relative to first input beam 3040, and further including an anamorphic-prism-pair system 2901 and a phosphor plate 3070, according to some embodiments of the present invention.

FIG. 31A is a top view of a dual rotating square-transparent-prism system 3101 with a rotating square-top rectangular-sided transparent prism 3110 in a first orientation relative to first input beam 3140, and further including a second rotating square-top rectangular-sided transparent prism 3120, according to some embodiments of the present invention.

FIG. 31B is a front view of a resulting pattern of scan lines 3182 generated by dual rotating square-transparent-prism system 3101, according to some embodiments of the present invention.

FIG. 31C is a side view of dual rotating square-transparent-prism system 3101.

FIG. 32A is a top view of a dual rotating polygonal-mirror system 3201 with a rotating square-polygon mirror 3210 in a first orientation relative to first input beam 3240, and further including a second rotating square-polygon mirror 3220, according to some embodiments of the present invention.

FIG. 32B is a front view of a resulting pattern of scan lines 3382 generated by dual rotating polygonal-mirror system 3201, according to some embodiments of the present invention.

FIG. 32C is a side view of dual rotating polygonal-mirror system 3201.

FIG. 33A is a side view of a rotating multi-faceted-mirror system 3301 with a rotating multi-faceted mirror 3310 in a first orientation relative to first input beam 3340 generated from laser source 3320, according to some embodiments of the present invention.

FIG. 33B is a front view of a resulting pattern of scan lines 3382 generated by dual rotating polygonal-mirror system 3101, according to some embodiments of the present invention.

FIG. 34 is a top view of a rotating multi-faceted-mirror system 3401 with a rotating multi-faceted mirror 3410, according to some embodiments of the present invention.

FIG. 35 is a side view of a rotating multi-faceted-mirror system 3501 with a rotating multi-faceted mirror 3510 in a first orientation relative to a plurality of input laser beams generated from laser sources 3510, 3520, 3530, and 3540, according to some embodiments of the present invention.

FIG. 36 is a front enlarged view of a plurality of scan lines 3582 on phosphor plate 3580 produced by rotating multi-faceted mirror 3510 and the plurality of input beams 3540, according to some embodiments of the present invention.

FIG. 37 is a side-view block diagram of a rotating multi-faceted-mirror system 3701 with three systems of rotating multi-faceted mirrors 3738, 3739, and 3740 all rotated by the same motor 3712 usable to generate a headlight beam 3890, a scanning LiDAR beam 3990 and provide for a scanning LiDAR receiver (not shown) for receiving reflected LiDAR signals 4090, according to some embodiments of the present invention.

FIG. 38 is a top view of a rotating multi-faceted-mirror system 3801 with rotating multi-faceted mirrors 3811 shown in three positions labeled 3811, 3811′ and 3811″, a phosphor plate 3880 and a system of one or more optional collimation and projection lenses 3870, and 3872, according to some embodiments of the present invention.

FIG. 39 is a top view of a rotating multi-faceted-mirror system 3901 with rotating multi-faceted mirrors 3911 shown in three positions labeled 3911, 3911′ and 3911″, according to some embodiments of the present invention.

FIG. 40 is a bottom view of a rotating multi-faceted-mirror system 4001 with rotating multi-faceted mirrors 4011 shown in three positions labeled 4011, 4011′ and 4011″, a line sensor 4080 and a system of one or more optional collimation or focussing lenses 4070, according to some embodiments of the present invention.

FIG. 41 is a side view of a rotating multi-faceted-mirror system 4101 with a system of rotating multi-faceted mirrors 4141 rotated by motor 4112 usable to generate a headlight beam 4190, according to some embodiments of the present invention.

FIG. 42 is a block diagram of a vehicle 4201 that includes a light source 4211, according to some embodiments of the present invention.

FIG. 43A is a top view of a square beam-splitter prism system 4301 with a square-top rectangular beam-splitter rotating prism 4310 in a first orientation relative to input beam 4340, according to some embodiments of the present invention.

FIG. 43B is a top view of square beam-splitter prism system 101 with rotating beam-splitter prism 4310 in a second orientation (indicated as 4310′) relative to input beam 140.

FIG. 43C is a top view of a square beam-splitter prism system 4302 with rotating beam-splitter prism 4310 in three different orientations (indicated as 4310, 4310′, 4310″) relative to input beam 4340, and a first reflective phosphor plate 4340 and a second reflective phosphor plate 4360, according to some embodiments of the present invention.

### DETAILED DESCRIPTION OF THE INVENTION

Although the following detailed description contains many specifics for the purpose of illustration, a person of ordinary skill in the art will appreciate that many variations and alterations to the following details are within the scope of the invention. Specific examples are used to illustrate particular embodiments; however, the invention described in the claims is not intended to be limited to only these examples, but rather includes the full scope of the attached claims. Accordingly, the following preferred embodiments of the invention are set forth without any loss of generality to, and without imposing limitations upon the claimed invention. Further, in the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The embodiments shown in the Figures and described here may include features that are not included in all specific embodiments. A particular embodiment may include only a subset of all of the features described, or a particular embodiment may include all of the features described.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

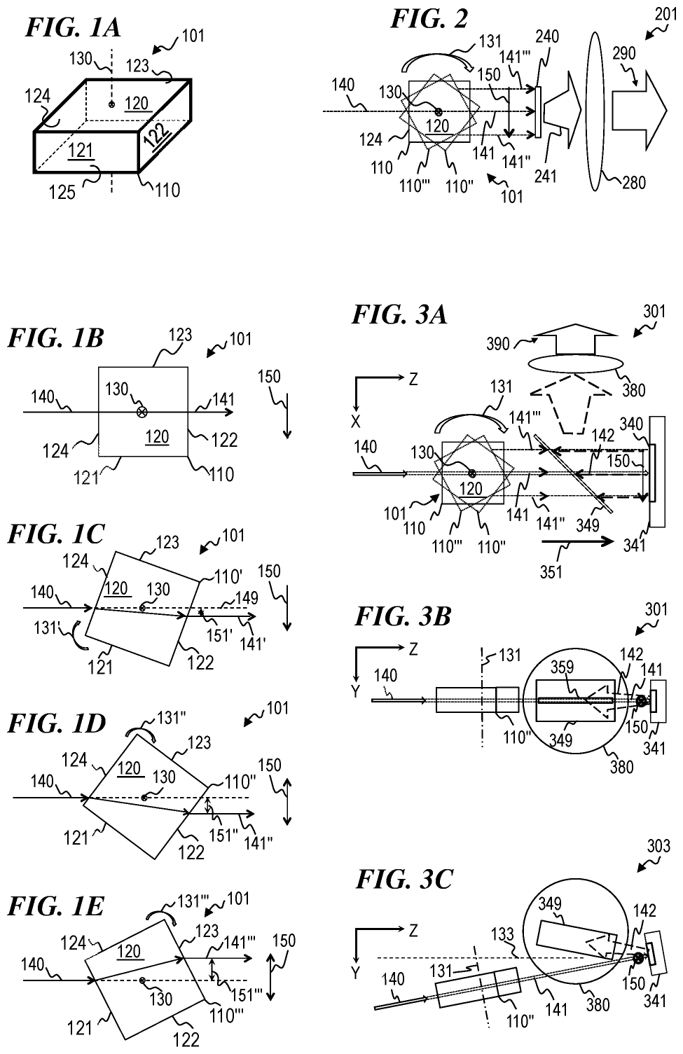

FIG. 1A is a perspective view of a square transparent prism system 101, according to some embodiments of the present invention, where the four sides (beam-input-and-output rectangular faces 121, 122, 123 and 124 that are each perpendicular to the top-side square face 120 and to bottom-side square face 125) are optically polished and optionally anti-reflection coated. In some embodiments, top-side square face 120 and/or bottom-side square face 125 are used for mounting to a mechanism such as a motor (not shown) used to rotate the prism around rotational axis 130.

FIG. 1B is a top view of square transparent prism system 101 with a square-top rectangular rotating prism 110 in a first orientation, here with input face 124 at ninety degrees (90°) relative to input beam 140, and thus with output face 122 at ninety degrees (90°) relative to output beam 141, and the output beam 141 propagation axis has zero displacement (i.e., by a first displacement amount, which is zero) from the propagation axis 149 (see FIG. 1C) of input beam 140. Rotating square prism 110 is mounted on a rotating platform (not shown) that continually rotates square prism 110 to different angular orientations relative to input beam 140.

FIG. 1C is a top view of square transparent prism system 101 with rotating prism 110 rotated (see curved arrow 131′) to a second orientation (indicated as 110′) of about one-hundred-and-ten degrees (110°) relative to input beam 140, and thus with output face 122 at seventy degrees (70°) relative to output beam 141′, which has a propagation axis that is displaced downward by a second amount 142′ in FIG. 1C.

FIG. 1D is a top view of square transparent prism system 101 with rotating prism 110 rotated (see curved arrow 131″) to a third orientation (indicated as 110″) of about one-hundred-and-twenty-seven degrees (127°) relative to input beam 140, and thus with output face 122 at fifty-three degrees (53°) relative to output beam 141″, which is displaced downward by a third amount 151″ in FIG. 1D.

FIG. 1E is a top view of square transparent prism system 101 with rotating prism 110 (see curved arrow 131′″) to a fourth orientation (indicated as 110′″) of about one-hundred-and-fifty-three degrees (153°) relative to input beam 140 such that input beam 140 now enters face 121, and thus beam 141′″ exits output face 123, which is displaced upward by a fourth amount 151′″ in FIG. 1E.

FIG. 2 is a top view of square transparent prism system 201 with rotating square prism 110 in three different orientations (indicated as 110, 110′, 110″) relative to input beam 140, and a transparent phosphor plate 240. Rotating square prism 110 is mounted on a rotating platform (not shown) that continually rotates square prism 110. The input laser beam 140 is directed towards an input face of square prism 110, passes through prism 110, and exits square prism 110 from an opposite face as beam 141 that is parallel to the original laser beam 140. As square prism 110 is rotated in direction 131 from position 110 (also as shown in FIG. 1B) to position 110″ (also as shown in FIG. 1D), the input laser beam 140 is refracted downward by the input surface 124 and directed toward the opposite face 122 (the lower-right side as shown in FIG. 1D) of the square prism 110 and exits the opposite surface 122 as output beam 141″ at a lower position, while remaining parallel to input laser beam 140 (as a consequence of being refracted in equal degree, but opposite directions, at the input face and output face of square prism 110). Thus, the output laser beam 141 is moved from the center position labeled 141, to a lower position labeled 141′ (as shown in FIG. 1D). As square prism 110 continues to rotate to the position labeled 110″ (also as shown in FIG. 1D), the output beam 141″ continues to move further in the lower position. As the square prism continues to rotate, when input laser beam 140 passes across the corner position between face 124 and face 121 of square prism 110, the beam is refracted inside square prism 110 upwards (as shown in FIG. 1E) in the opposite direction than was the case in FIGS. 1C and 1D, above the line of the input-laser-beam position, as shown in FIG. 1E. As square prism 110 continues to rotate, the output beam 141 will be scanning from the top to the bottom, as shown by arrow 150 in the figures, and will jump from the lowest position 141″ to the highest position 141′″ each time input beam 140 passes by a corner of square prism 110.

Continuing, the embodiment shown in FIG. 2 of prism system 201 can be used as a square-transparent prism-adaptive-driving-beam (ADB) headlight system, with rotating square prism 110 shown in three different rotational orientations (indicated as 110, 110′, 110″) relative to input beam 140. In some embodiments, ADB-headlight system 201 includes a rotating-square-prism beam-scanning system 101, a transmissive phosphor plate 240, and a projection lens 290. As square prism 110 is rotating around its vertical axis 130, the output laser beam 141 (e.g., in some embodiments, a blue-wavelength laser beam) is scanned in direction 150 across transmissive phosphor plate 240, forming a line with visible-light emission from the phosphor(s) in the phosphor plate 240, converting the laser light 141 (e.g., one or more blue wavelengths, indicated by short dashed lines) at least partially into one or more longer wavelengths (e.g., in some embodiments, resulting in white light, wherein the phosphor(s) are chosen to provide a desired wavelength spectrum). In some embodiments, projection lens 280 then transforms the output light 241 (in some embodiments, emitted in a diverging Lambertian pattern) from phosphor plate 240 into the required light pattern of output light beam 290 onto the roadway. In some embodiments, selective dimming and/or ON/OFF functionality imposed on different selected portions of output beam 290 is achieved by controlling the drive current of the laser(s) that generate(s) laser beam 140 in synchronism with the angle of rotating square prism 110 that controls the positions of scanning laser beam 141 on transmissive phosphor plate 240.

In some embodiments, laser beam 140 is focused (e.g., by one or more lenses (not shown)) into a round spot onto transmissive phosphor plate 240 such that the output light beam 290 is a scanning spot of light moved across a line (which, in some embodiments, is repeatedly moved across the pattern at high-enough speed that the beam appears constant to the human eye). In other embodiments, the laser beam is focused into a (e.g., vertical) line of light on phosphor plate 240 such that the output beam 290 is a scanning band of light. In addition, in some embodiments, an array of two or more lasers is used to generate a plurality of laser beams 140 such that multiple round spots or lines of light from phosphor plate 240 are projected onto the roadway with another dimension of illumination control because each of the plurality of lasers is independently controlled to be selectively dimmed or turned on and off. For example, if ten (10) laser beams are used, the pattern of output light beam 290 on the roadway can be modulated with ten vertical regions, each selectively dimmed or turned on and off for its own portion of the headlight beam 290, producing a two-dimensional (2D) light pattern.

FIG. 3A is a top view of a rotating square-transparent prism ADB-headlight system 301 with rotating prism 110 shown in three different orientations (indicated as 110, 110′, 110″) relative to input beam 140, and a reflective phosphor plate 340 mounted on an optional heat sink 341, such that phosphor plate 340 is heat sunk to remove heat with high effectiveness, thus allowing higher-power operations than possible with the transmissive phosphor plate 240 of system 201 of FIG. 2. In some embodiments, reflector 349 is highly reflective to all wavelengths on most of the surface facing phosphor plate 340, but includes an elongated slot aperture (such as slot 359 shown in FIG. 3B) shaped to allow the focused scanning laser beam 141 to pass through from its lowest extent 141″ to its upper-most extent 141′″. In other embodiments, reflector 349 has a wavelength-sensitive filter that is highly transmissive to, and passes the wavelengths of, scanning beam 141 and is highly reflective of, and reflects the wavelengths of, light emitted by phosphor plate 340. In still other embodiments, reflector 349 combines the two approaches just mentioned, and thus is highly reflective to all wavelengths on most of the surface facing phosphor plate 340, but includes an elongated slot aperture covered by a wavelength-sensitive filter that is highly transmissive to, and passes the wavelengths of, scanning beam 141 and is highly reflective and reflects the wavelengths of light emitted by phosphor plate. Thus, in some embodiments, scanning laser beam 141 passes through the slot aperture in reflector 349, optionally with a wavelength-sensitive filter that passes blue light (here, of scanning laser beam 141) and reflects yellow light (here, emitted from laser-excited phosphor plate 340), and the beam passed by reflector 349 propagates towards reflective phosphor plate 340. The wavelength-converted emission from phosphor plate 340 then propagates back toward reflector 349 and is reflected upwards towards projection lens 380. The scanning of the output light is then projected as a scanning beam 390 onto the roadway. Selective dimming or ON/OFF control of various parts of output beam 390 is again achieved by controlling the drive current of the laser(s) in synchronism with the angle of rotating square prism 110 that controls the position of the scanning laser beam 141 on phosphor plate 340.

FIG. 3B is a side view of one embodiment of square transparent prism system 301 with rotating prism 110 in the third orientations (indicated 110″) relative to a horizontal input beam 140, according to some embodiments of the present invention.

FIG. 3C is a side view of an alternative square transparent prism system 303 (which would have a top view substantially similar to FIG. 3A) with rotating prism 110 in the third orientations (indicated 110″) relative to tilted-to-horizontal input beam 140, according to some embodiments of the present invention. In this embodiment, the tilted-to-horizontal input beam 140 and the rotating prism 110 (shown in a third rotational orientation of top-view FIG. 3A) are at a tilted angle relative to the horizontal plane 133, and thus the input scanning beam 141 is incident onto the phosphor plate 340 at an angle from below the horizontal plane 133, such that the reflector 349 does not interfere with scanning beam 141. In this case, reflector 349 can be simply a plane mirror without any wavelength-selective or slot features.

In a manner similar to system 201 in FIG. 2, in some embodiments of system 301 laser beam 141 is focused into a round spot that is scanned across a line (top to bottom in FIG. 3A) onto the phosphor plate such that the output beam 390 is a spot of light that is scanned across a line, in some embodiments, repeatedly scanned left-to-right. In other embodiments, laser beam 141 is focused into a line of light (e.g., in some embodiments, a horizontal line) such that the output is a scanning band of light (the horizontal line scanned left-to-right). In addition, in some embodiments, an array of lasers is used such that multiple round spots or lines of lights are projected onto the roadway with another dimension of illumination control, as described above for FIG. 2. For each rotation of prism 110, the output beam 141 will scan across the phosphor plate 340 four times (referring to FIGS. 1B, 1C and 1D again, a first scan will occur when the beam 140 enters face 124 and exits face 122 as beam 141; referring to FIG. 1E again, a second scan will occur when the beam 140 enters face 121 and exits face 123 as beam 141, then as prism 110 continued to rotate, a third scan will occur when the beam 140 enters face 122 and exits face 124 as beam 141, and a fourth scan will occur when the beam 140 enters face 123 and exits face 121 as beam 141, and then this process repeats).

As square prism 110 is rotating around its axis 130, the path lengths change from one position to another; as a result, for scanning beam 141 to be focused at the phosphor plate at all times, in some embodiments, phosphor plate 340 is formed having a curved front surface with a curvature matching the path lengths. Accordingly, in some embodiments, projection lens 380 is also designed to accommodate the curvature of phosphor plate 340, providing the required patterns on the roadway.

In other embodiments of FIGS. 3A, 3B and 3C (not shown), still using a single square rotating prism 110 with perpendicular sides 121, 122, 123 and 124, a plurality of two or more parallel input beams 140 are used, one above the other, and thus two or more parallel scanning beams 141 (one scanning beam for each input beam) are produced and projected onto phosphor 340.

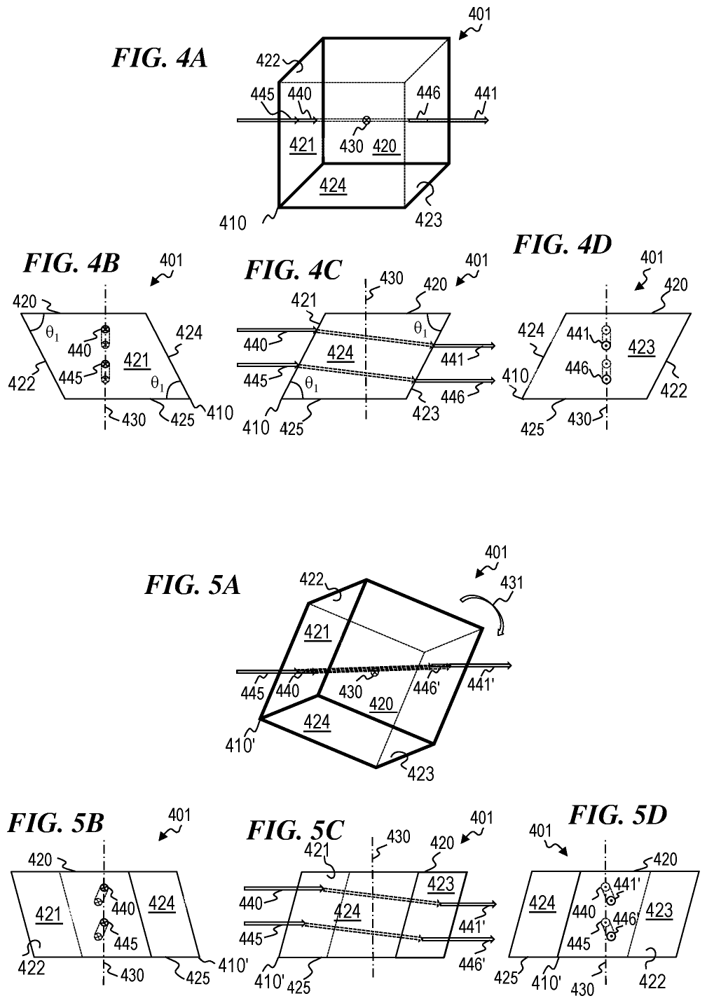

In other embodiments, such as shown in FIGS. 4A-5D and 5A-5D, the opposite parallel sides of the prism are tilted at the same angle to the rotational axis, and thus two successive scanning output beams per rotation of the prism are produced for each parallel input beam.

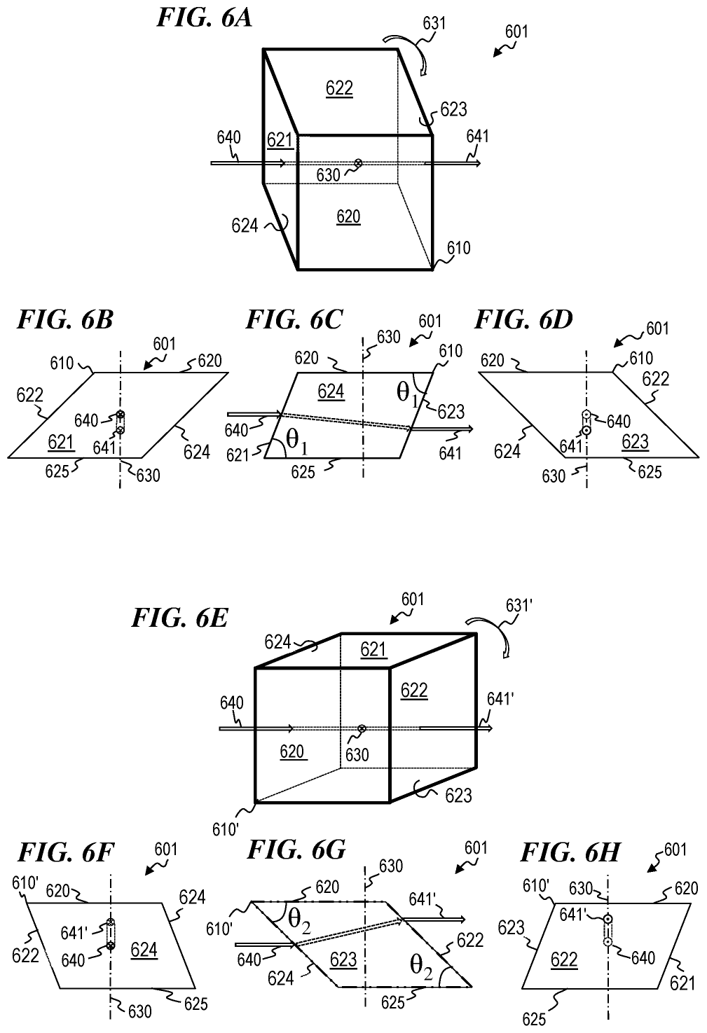

In still other embodiments, such as shown in FIGS. 6A-6H, 7A-7H and 8, the opposite parallel sides of the prism are tilted at different angles to the rotational axis, and thus four successive scanning output beams per rotation of the prism are produced for each parallel input beam.

FIG. 4A is a top view of a rotating-transparent-prism system 401 with a rotating square-top, slanted-angle-sided transparent prism 410 in a first orientation (indicated as 410, in contrast to the orientation 410′ shown in FIGS. 5A-5E) relative to two parallel input beams (first input beam 440 and second input beam 445) and two scanned output lines 441 and 446 (which are vertically above one another as shown in FIG. 4B, FIG. 4C and FIG. 4D, but here are shown superimposed due to the top view) per pair of sides of the prism, according to some embodiments of the present invention. In some embodiments, the four polished input/output side faces, 421, 422, 423, and 424, are slanted relative to top face 420 and bottom face 425 (i.e., the side faces 421 and 423 are parallel to one another and are at an angle θ₁ relative to top face 420 and bottom face 425, respectively, and side faces 424 and 424 are parallel to one another and are also at an angle θ₁ relative to top face 420 and bottom face 425, respectively), such that horizontal scanning beam 441 and horizontal scanning beam 446 each have the same vertical positions leaving successive output faces as prism 410 is rotated around its axis 430, allowing two scanned lines of output-light that each move up and down due to different angles of rotating prism 410.

FIG. 4B is a left-side-elevation view of rotating-transparent-prism system 401 with rotating square-top angle-sided transparent prism 410 in the first orientation (indicated as 410) relative to first input beam 440 and second input beam 445.

FIG. 4C is a front-side-elevation view of rotating-transparent-prism system 401 with rotating square-top angle-sided transparent prism 410 in the first orientation (indicated as 410) relative to first input beam 440 and second input beam 445.

FIG. 4D is a right-side-elevation view of rotating-transparent-prism system 401 with rotating square-top angle-sided transparent prism 410 in the first orientation (indicated as 410) relative to first output beam 441 and second output beam 446.

FIG. 5A is a top view of rotating-transparent-prism system 401 with rotating square-top angle-sided transparent prism 410 in a second angular orientation (indicated as 410′) relative to first input beam 440 and second input beam 445 (which are vertically above one another as shown in FIG. 5B, FIG. 5C and FIG. 5D, but here are shown superimposed due to the view) and relative to first exit beam 441 and second exit beam 446 (which are also vertically above one another as shown in FIG. 5B, FIG. 5C and FIG. 5D, but here are shown superimposed due to the view), according to some embodiments of the present invention.

FIG. 5B is a left-side-elevation view of rotating-transparent-prism system 401 with rotating transparent prism 410 in the second orientation 410′ relative to first input beam 440 and second input beam 445.

FIG. 5C is a front-side-elevation view of rotating-transparent-prism system 401 with rotating prism 410 in the second orientation 410′ relative to first input beam 440 and second input beam 445 and relative to first exit beam 441′ and second input beam 446′.

FIG. 5D is a right-side-elevation view of rotating-transparent-prism system 401 with rotating transparent prism 410 in the second orientation 410′ relative to first exit beam 441′ and second input beam 446′.

Note that exit beams 441′ and 446′ are displaced left and right as well as up and down as rotating square-top angle-sided transparent prism 410 is rotated in direction 431 around axis 430.

Note also that FIGS. 4A-4D and 5A-5D show two parallel input beam and two parallel output beams, but the two pairs of input/output faces 421-423 and 424-422 are shown with the same tilt angle to the rotational axis 430, so there is one output scan beam for each input beam, but each output scan beam is generated twice for each rotation of the prism 401. Then, as described below, FIGS. 6A-6H and 7A-7H and 8 show the two pairs of input/output faces 621-623 and 624-622 having different tilt angles to the rotational axis, but only a single input beam. This is for clarity of the Figures. Note that other embodiments of system 601 (not shown) include a plurality of parallel input beams and correspondingly two output scan lines for each input laser beam, but each output scan line is generated once for each rotation of the prism 601.

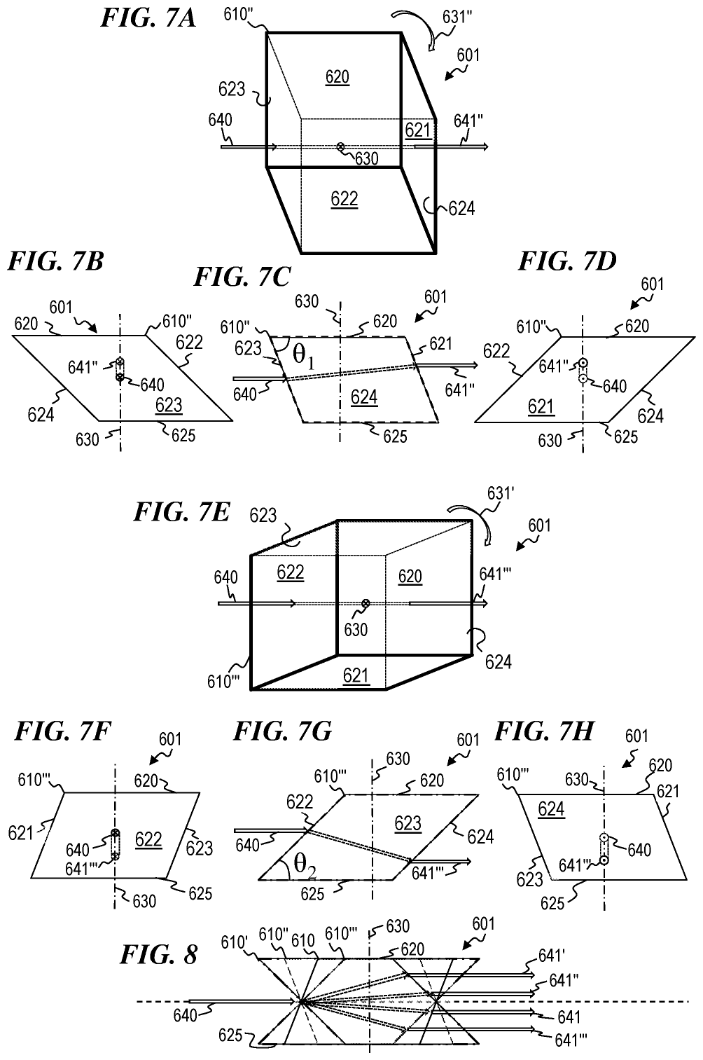

FIG. 6A is a top view of a rotating-transparent-prism system 601 with a rotating square-top angle-sided transparent prism 610 in a first orientation (indicated as 610, in contrast to the orientation 610′ shown in FIGS. 6E-6H) relative to first input beam 640 and first exit beam 641 having a first displacement, according to some embodiments of the present invention. In some embodiments, input face 621 is parallel to output face 623, and both are at the same angle θ₁ relative to the bottom face 625 and top face 620 respectively, as shown in FIG. 6C. In some embodiments, face 624 is parallel to face 622, and both are at the same angle θ₂ relative to the top face 620 and bottom face 625, respectively, as shown in FIG. 6G. Note that angle θ₁ and angle θ₂ are different from one another, such that the amount of vertical displacement between input laser beam 640 and the parallel output beam 641 (displaced downward by a first amount, indicated by reference number 641 as shown in FIG. 6C and FIG. 8, or upward by a first amount, indicated by reference number 641″ as shown in FIG. 7C and FIG. 8) is different when passing through faces 621 and 623 as compared to the vertical displacement of the output beam (upward by a second amount, indicated by reference number 641′ as shown in FIG. 6G and FIG. 8, or downward by a second amount, indicated by reference number 641′″ as shown in FIG. 7G and FIG. 8) when passing through faces 622 and 624, thus generating two different scan lines for each input laser beam. This provides two different displacement amounts (which in turn depend on the different angles θ₁ and θ₂) for each input laser beam when a plurality of two or more parallel input laser beams are used, such as shown in FIGS. 4A-4D and 5A-5D.

Note that in some embodiments (not shown combined together), a plurality of two (or more) stacked laser input beams (such as shown in FIGS. 4A-4D and 5A-5D) are used as the laser beam inputs (rather than just a single input beam 640) into rotating-transparent-prism system 601 shown in FIGS. 6A-6H and 7A-7H, to increase the number of output scan lines.

FIG. 6B is a left-side-elevation view of rotating-transparent-prism system 601 with rotating square-top angle-sided transparent prism 610 in the first orientation (indicated as 610) relative to first input beam 640 and its parallel exit beam 641 having the first downward displacement that depends on angle θ₁ as shown in FIG. 6C.

FIG. 6C is a front-side-elevation view of rotating-transparent-prism system 601 with rotating square-top angle-sided transparent prism 610 in the first orientation (indicated as 610) relative to first input beam 640 and exit beam 641 having the first displacement. Note again, the angle θ₁ between top face 620 and output face 623 is the same as angle θ₁ between bottom face 625 and input face 621, as shown in FIG. 6C, and the angle θ₂ between top face 620 and input face 624 is the same as angle θ₂ between bottom face 625 and output face 622, as shown in FIG. 6G, and angle θ₁ is different than angle θ₁.

FIG. 6D is a right-side-elevation view of rotating-transparent-prism system 601 with rotating square-top angle-sided transparent prism 610 in the first orientation (indicated as 610) relative to first input beam 640 and exit beam 641 having the first displacement.

FIG. 6E is a top view of rotating-transparent-prism system 601 with rotating square-top angle-sided transparent prism 610 in the second orientation (indicated as 610′, which is rotated 90° from the first orientation shown in FIGS. 6A-6D) relative to first input beam 640 and exit beam 641′ having a second displacement (see also FIG. 8).

FIG. 6F is a left-side-elevation view of rotating-transparent-prism system 601 with rotating square-top angle-sided transparent prism 610 in the second orientation (indicated as 610′) relative to first input beam 640 and exit beam 641′ having the second displacement.

FIG. 6G is a front-side-elevation view of rotating-transparent-prism system 601 with rotating square-top angle-sided transparent prism 610 in the second orientation (indicated as 610′) relative to first input beam 640 and exit beam 641′ having the second displacement.

FIG. 6H is a right-side-elevation view of rotating-transparent-prism system 601 with rotating square-top angle-sided transparent prism 610 in the second orientation (indicated as 610′) relative to first input beam 640 and exit beam 641′ having the second displacement.

FIG. 7A is a top view of a rotating-transparent-prism system 601 with rotating square-top angle-sided transparent prism 610 in a third orientation (indicated as 610″, which is rotated 180° from the first orientation shown in FIGS. 6A-6D, (and 90° from the second orientation shown in FIGS. 6E-6H) relative to first input beam 640 and exit beam 641″) having a third displacement (see also FIG. 8), according to some embodiments of the present invention.

FIG. 7B is a left-side-elevation view of rotating-transparent-prism system 601 with rotating square-top angle-sided transparent prism 610 in the third orientation (indicated as 610″) relative to first input beam 640 and to first input beam 640 and exit beam 641″ having the third displacement.

FIG. 7C is a front-side-elevation view of rotating-transparent-prism system 601 with rotating square-top angle-sided transparent prism 610 in the third orientation (indicated as 610″) relative to first input beam 640 and exit beam 641″ having the third displacement.

FIG. 7D is a right-side-elevation view of rotating-transparent-prism system 601 with rotating square-top angle-sided transparent prism 610 in the third orientation (indicated as 610″) relative to first input beam 640 and exit beam 641″ having the third displacement.

FIG. 7E is a top view of rotating-transparent-prism system 601 with rotating square-top angle-sided transparent prism 610 in a fourth orientation (indicated as 610′″, which is rotated 270° from the first orientation shown in FIGS. 6A-6D and 90° from the third orientation shown in FIGS. 7A-7D) relative to first input beam 640 and exit beam 641′″ having a fourth displacement (see also FIG. 8).

FIG. 7F is a left-side-elevation view of rotating-transparent-prism system 601 with rotating square-top angle-sided transparent prism 610 in the fourth orientation (indicated as 610′″) relative to first input beam 640 and exit beam 641′″ having the fourth displacement.

FIG. 7G is a front-side-elevation view of rotating-transparent-prism system 601 with rotating square-top angle-sided transparent prism 610 in the fourth orientation (indicated as 610′″) relative to first input beam 640 and exit beam 641′″ having the fourth displacement.

FIG. 7H is a right-side-elevation view of rotating-transparent-prism system 601 with rotating square-top angle-sided transparent prism 610 in the fourth orientation (indicated as 610′″) relative to exit beam 641′″ having the fourth displacement.

FIG. 8 is a front-side-elevation view of rotating-transparent-prism system 601 with rotating square-top angle-sided transparent prism 610 in the four orientations (indicated as 610 in solid lines as in FIG. 6C, 610′ in wide dash-dot-dot lines over light solid lines as in FIG. 6G, 610″ in wide dash lines over light solid lines as in FIG. 7C, and 610′″ in wide dash-dot lines over light solid lines as in FIG. 7G) relative to first input beam 640. The amounts of vertical displacement of the exit beams 641, 641′, 641″ and 641′″ depend on the angle θ₁ and angle θ₂ between the top and bottom faces 620 and 625 and the respective input/output face pairs 621-623 and 622-624, as well as the varied rotational angle 631 as each complete rotation is completed.

In total, in some embodiments, such as shown in FIGS. 6A-6H, 7A-7H and 8, there are four successive-in-time scan lines generated per full rotation of this angled-sided prism 610 that has two different pairs of parallel sides of different tilt angles relative to the rotational axis 630 using a single input laser beam 640. In other embodiments, when two or more parallel input laser beams are used, a total of eight or more scan lines are produced (four scan lines for each parallel input beam). When the horizontal input beam 640 passes through each input face 621, 622, 623 and 624, the beam is refracted downwards or upwards towards the respective output face 623, 624, 621 and 622, below or above the centerline propagation axis of input beam 640, and exits as output beam 641 in the horizontal direction parallel to input beam 640 at a variable distance above or below the centerline. As the prism is rotated around its vertical axis 630, the first displacement distance downward for exit beam 641 shown in FIG. 8 and FIG. 6C is equal to the third displacement distance upward for exit beam 641″ shown in FIG. 8 and FIG. 7C, and the third displacement distance upward for exit beam 641′ shown in FIG. 8 and FIG. 6G is equal to the fourth displacement distance downward for exit beam 641′″ shown in FIG. 8 and FIG. 7G. As the square-top prism 610 with its two pairs of slanted side surfaces (parallel pair 621 and 623 and parallel pair 624 and 622) at two different angles rotates (for example, initially the beam enters face 621 and exits face 623 as in FIG. 6C, and next enters face 624 and exits face 622 as in FIG. 6G), four horizontal scanning lines as shown in FIG. 8 are successively produced (at four successive periods of time on each rotation of prism 610), allowing the scanning of the headlight beam at four different vertical positions onto the roadway. In some embodiments, when prism 610 is rotated at sufficiently high speeds, the four different vertical positions of the headlight beam will be perceived as “constantly on” to a human viewer (when the input laser is “on” for that portion of the headlight pattern), rather than being seen as successively generated, or flickering.

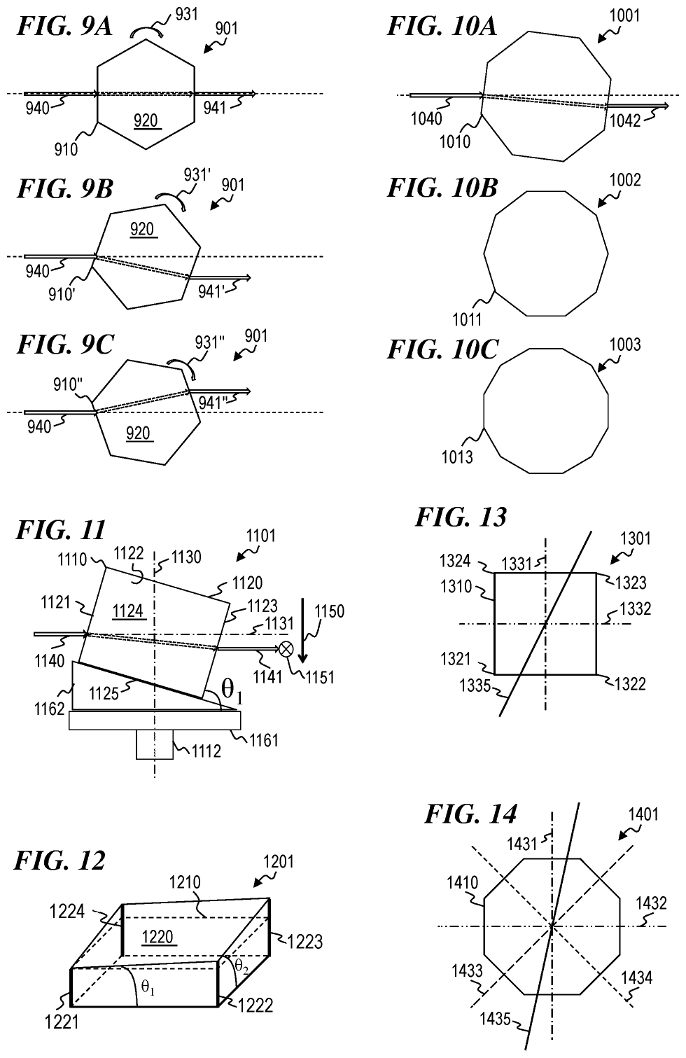

FIG. 9A is a top view of a top face 920 of a rotating-transparent-prism system 901 with rotating hexagonal-top rectangular-sided transparent prism 910 in a first orientation (indicated as 910) relative to first input beam 940, according to some embodiments of the present invention.

FIG. 9B is a top view top face 920 of rotating-transparent-prism system 901 with rotating hexagonal-top rectangular-sided transparent prism 910 in a second orientation (indicated as 910′) relative to first input beam 940.

FIG. 9C is a top view of top face 920 rotating-transparent-prism system 901 with rotating hexagonal-top rectangular-sided transparent prism 910 in a third orientation (indicated as 910″) relative to first input beam 940.

FIGS. 9A, 9B and 9C show three positions of angular rotation of an embodiment of the invention that uses hexagonal prism 910 with three pairs of parallel side surfaces (not shown), which, in some embodiments, are slanted at three different angles relative to the horizontal top face 920 of the prism 910, such that output beam 941 scanning at three different levels above and three different levels below an input-beam propagation axis of each of one or more parallel input beams (two or more such input beams, such as shown in FIGS. 4A-4D, and 5A-5D) is produced, with a total of six successive-in-time lines of output light having six vertical positions for each input beam 940, allowing more flexibility in the output light pattern.

FIG. 10A is a top view of a rotating-transparent-prism system 1001 with rotating octagonal-top, rectangular-sided-faces transparent prism 1010 in a first orientation relative to first input beam 1040, according to some embodiments of the present invention.

FIG. 10B is a top view of a rotating-transparent-prism system 1002 with rotating ten-sided-top, rectangular-sided-faces transparent prism 1011 in a first orientation relative to first input beam 1040, according to some embodiments of the present invention.

FIG. 10C is a top view of a rotating-transparent-prism system 1003 with rotating twelve-sided-top, rectangular-sided-faces transparent prism 1013 in a first orientation relative to first input beam 1040, according to some embodiments of the present invention.

FIGS. 10A, 10B and 10C further extend the design to eight-sided, ten-sided, and twelve-sided polygons, with correspondingly more pairs of parallel faces at different slanted angles relative to the top and bottom faces (four different slant angles for the four pairs for FIG. 10A, five different slant angles for the five pairs for FIG. 10B, or six different slant angles for the six pairs for FIG. 10C, respectively) for the sides, for even more scanning output lines. Similarly, fourteen-sided or more-sided polygons can be made, to produce even more lines at the output for each parallel input beam.

FIG. 11 is a front-elevational view of rotating-transparent-prism system 1101 with rotating square-top angle-sided transparent prism 1110, mounted on a wedge-spacer 1162 that is rotated by motor 1112, when in a first orientation relative to first input beam 1140, according to some embodiments of the present invention. FIG. 11 shows one of the embodiments where the slanting of the prism sides is achieved by tilting a square prism (e.g., a square prism with four sides that are perpendicular to the top and bottom square faces), wherein the prism is oriented at an angle to the horizontal using a tilter spacer, as shown. If the spacer is tilted in one direction (shown by angle θ₁ in FIG. 11), the output beam deviation will occur in downward direction 1150 only when the light beam 1140 enters face 1121 or 1123, and output beam 1141 scans in a direction 1151 (whether the beam moves toward the sheet and away from the viewer, as shown here, depends on the direction of rotation of prism 1110 around its rotational axis 1139) perpendicular to the sheet of FIG. 11. When the prism is turned for the input beam 1140 to enter the other faces 1122 and 1124, the scanned output beam 1141 will not be deviated vertically from the propagation axis 1131 of the input beam 1140.

FIG. 12 is a perspective view of a spacer 1201 usable in rotating-transparent-prism system 1101, wherein spacer 1201 includes angular deviations in two directions, according to some embodiments of the present invention. As a result, deviations in two different amounts up and down are provided, since spacer 1201 is tilted in different amounts in the X and Y directions, as shown in FIG. 12. In this case, the heights 1222, 1223, and 1224 relative to height 1221 are determined by the amount of slant angle θ₁ and slant angle θ₂ in the two X and Y directions. The height 1224 will be a dependent variable calculated from 1221, 1222, and 1223 to make top surface 1220 a single plane.

FIG. 13 is a top view of a spacer 1301 usable in rotating-transparent-prism system 1101 of FIG. 11, wherein spacer 1301 includes angular deviations in two directions such that the tilt axis 1335 does not correspond to axis 1331 or axis 1332 of a square prism to be mounted on spacer 1301, such as prism 1110 of FIG. 11, according to some embodiments of the present invention. In this case, the heights of the corners 1322, 1323, and 1324 relative to height 1321 are determined by the amount of slant angle θ₁ and slant angle θ₂ (see FIG. 12) in the two X and Y directions. In order to provide the two slant angles θ₁ and θ₂, the tilting axis 1335 has to be different from the prism axes 1331 and 1332, as shown in FIG. 13. In this case, the prism axis 1331 and prism axis 1332 are perpendicular to the respective faces of the square prism 1310. In some embodiments, spacer tilt axis 1335 is chosen (e.g., as shown) as determined by the desired amount of tilt in both X and Y directions.

FIG. 14 is a top view of a spacer 1401 usable in rotating-transparent-prism system that uses an octagonal spacer 1410 and a prism such as octagonal prism 1310 of FIG. 10A, wherein spacer 1410 includes angular deviations in two directions such that the tilt axis 1435 does not correspond to any of the four axes 1431. 1432, 1433 and 1434 of the octagonal prism such as 1010 of FIG. 10A, according to some embodiments of the present invention. In general, as shown in the example in FIG. 14, which is for an eight-sided prism having faces that are perpendicular to the top and bottom faces, the spacer tilt axis 1435 is chosen such that it is not any one of the four prism axes 1431. 1432, 1433 and 1434. In some embodiments, the exact spacer-tilt axis 1435 is determined by the four slant angles required by the scanning system.

In general, the spacer-tilt axis can fall in any direction, as required by the design of the output pattern; in particular, in one of the embodiments, the spacer-tilt axis passes through the opposite corners of the prism such that the output beams have a highest number of different or independent scanning lines of light.

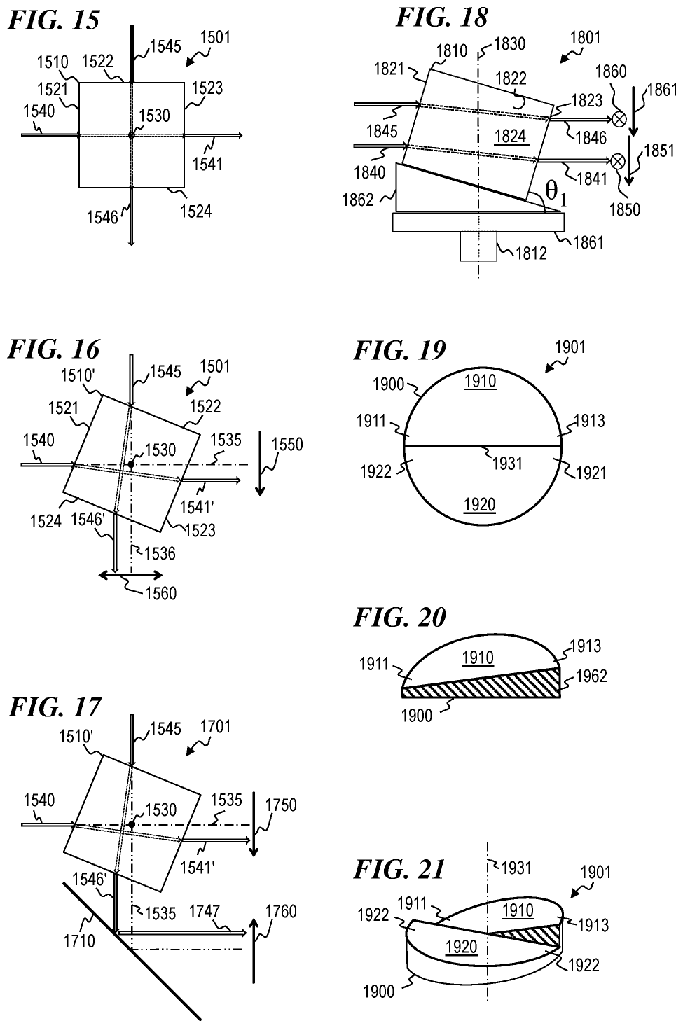

FIG. 15 is a top view of a rotating-transparent-prism system 1501 with a rotating square-top rectangular-sided transparent prism 1510 in a first orientation (indicated as 1510, in contrast to the orientation 1510′ shown in FIG. 16) relative to first input beam 1540 and second input beam 1545, each approaching different input faces (e.g., 1521 and 1522, respectively, in this first orientation). In some embodiments, rotating square prism 1510 is a square-top rectangular-sided prism (such as shown in FIG. 1A), but here the square prism 1510 receives two input beams 1540 and 1545 propagating towards the square transparent prism 1510 from two directions (e.g., in this FIG. 15, input beam 1540 from the left of the drawing and input beam 1545 from the top of the drawing), such that two independent output beams 1541 (scanned in direction 1550) and 1546 (scanned in direction 1560) are scanned simultaneously by the same square prism 1510 when the square prism 1510 is rotating. In some embodiments, the two scanned output beams 1541 and 1546 are used independently.

FIG. 16 is a top view of a rotating-transparent-prism system 1501 with a rotating square-top rectangular-sided transparent prism 1510 in a second orientation (indicated as 1510′) relative to first input beam 1540 and second input beam 1545, such that both output beams 1541′ and 1546′ are deviated from their respective centerlines 1535 and 1536.

FIG. 17 is a top view of a rotating-transparent-prism system 1701 with a rotating square-top rectangular-sided transparent prism 1510 in a second orientation (indicated as 1510′) relative to first input beam 1540 and second input beam 1545, and further including a flat mirror 1710 to reflect the second scanning beam 1546 (shown here as deflected to position 1546′) to be scanning beam 1747, which is parallel to scanning beam 1541 in some embodiments of the present invention. FIG. 17 shows an embodiment where reflector 1710 has been added, to reflect the output of output scanning beam 1747 to a perpendicular path to the direction of the intermediate scanning beam 1546. In other embodiments (not shown), both scanning beams 1541 and 1747 can be redirected to their respective desired directions using the appropriate optical components.

When the same method is applied to a hexagonal prism (such as shown in FIGS. 9A, 9B and 9C), three independent input beams impinge on three different faces of the hexagonal prism 910 simultaneously and are scanned to three scanning output beams (in three different directions each parallel to the three respective input beam, since the hexagonal prism can accept input beams propagating towards the hexagonal transparent prism from three directions such that three independent output beams are scanned simultaneously by the same hexagonal prism when the hexagonal prism is rotating. Following the same approach, in embodiments with prisms having a greater number of sides in the prism, more independent input beams can be used to generate additional scanned output beams.

FIG. 18 is a front-elevational view of rotating-transparent-prism system 1801 with rotating square-top angle-sided transparent prism 1810, mounted on a wedge-spacer 1862 that is rotated by motor 1812, when in a first orientation relative to first input beam 1840 and second input beam 1845, both approaching the same input face (e.g., 1821 in this first orientation), according to some embodiments of the present invention. FIG. 18 shows an embodiment where two input beams are placed one on top of another (e.g., in some embodiments, the two input beams are parallel to one another), such that both beams are scanned, producing two output beams (e.g., two parallel scanned beams) when the square prism 1810 is rotating (e.g., beam 1841 scanning in direction 1850 (into the sheet depending on the rotational direction of prism 1810 around axis 1830) while deflected in downward direction 1851, and beam 1846 scanning in the same direction 1860 (into the sheet depending on the rotational direction of prism 1810 around axis 1830) while deflected in downward direction 1861). In some embodiments, spacer 1862 is tilted to different slant angle θ₁ and slant angle θ₂ such as shown in FIGS. 12 and 13, to provide two different tilt angles for the two pairs of parallel input/output faces 1821-1823 and 1822-1824. In general, and as implemented in various embodiments, more than two parallel beams can be stacked on top of, and/or beside each other and/or additional stacked beams approach different input faces such as shown in FIGS. 16-17, producing even more scanning output beams. Combining the approach of having beams impinging from different directions on multiple faces of a prism and stacked on top of each other (e.g., a plurality of parallel beams stacked on one another directed to each of a plurality of faces of the prism), a single rotating prism can produce multiple scanning beams for various applications.

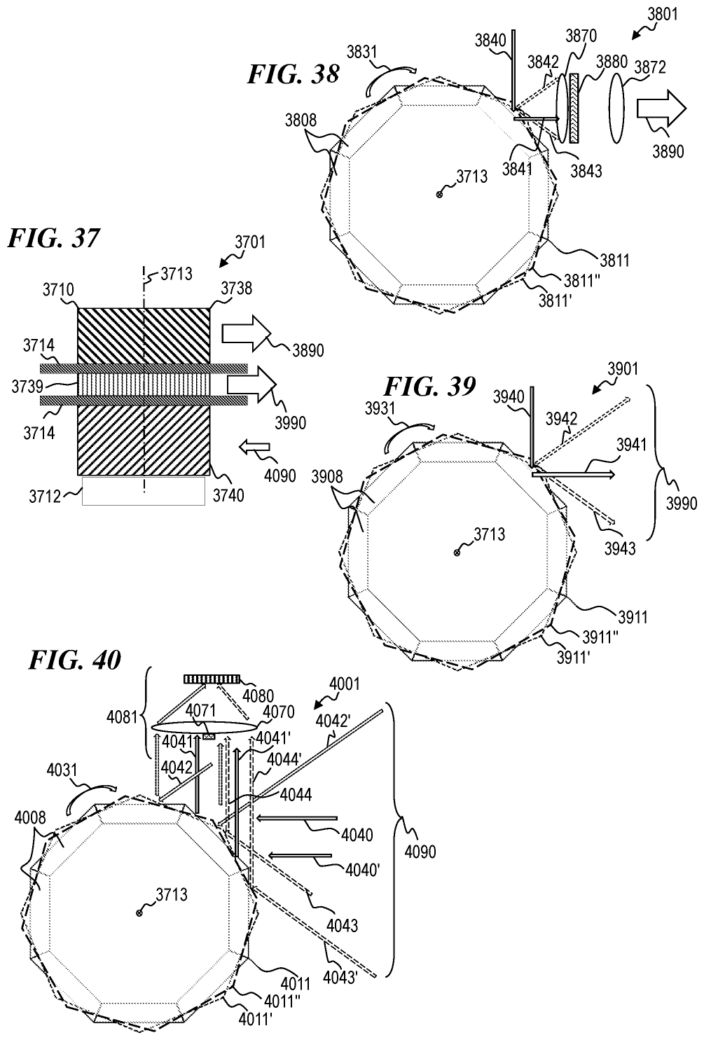

As an example, in some embodiments, the scanning beams, combined with the appropriate wavelength converters (such as transmissive or reflective phosphor plates), and a controller such as controller 4290 shown in FIG. 42, are used for generating a light profile that includes one or more automotive-headlight output beams, including low beam, high beam, or ultra-high beam only, or a desired combination, etc. With such a light profile, having a variably controlled shape and brightness, projected onto the roadway together with the intensity-modulation capability of the laser(s) under the control of a controller (such as shown in FIG. 42, described below), the desired output shape-and-intensity profile is produced, such as lighting various portions or subsets of low beam only, high beam only, or ultra-high beam only, or a desired combination. In addition, in some embodiments other scanning beams include one or more pulsed infrared laser (IR) beams used for LiDAR application targeting, with one or more output beams targeting at one or more directions (such as described in FIGS. 37, 39, 40 and 42, for example).

FIG. 19 is a top view of a rotating-dual-mirror system 1901 that includes two semi-circular planar mirrors 1910 and 1920 mounted to or formed on a circular double-wedge-shaped substrate 1900, according to some embodiments of the present invention. In some embodiments, headlight applications using light sources such as light-emitting diodes (LEDs), or laser-excited phosphors, use a tilted-mirror embodiment such as shown in FIG. 19. FIG. 19 uses two semi-circular planar mirrors 1910 and 1920 mounted or formed on a circular double-wedge-shaped substrate 1900 (alternatively, substrate 1900 may be other shapes, such as using two different wedge angles). The mirrors 1910 and 1920 are tilted in the opposite direction such that there are high levels 1913 and 1922, and low levels 1911 and 1921, as shown more clearly in FIG. 21. The dual-mirror system 1901 is rotated around the central rotation axis 1931.

FIG. 20 is a perspective view of half of rotating-dual-wedged-mirror system 1901 (shown in its entirety in FIG. 21), showing semi-circular planar mirror 1910 mounted to or formed on double-wedge-shaped substrate 1900, wherein the cross-section 1962 is a wedge.

FIG. 21 is a perspective cross-section view of rotating-dual-mirror system 1901 that includes two semi-circular planar mirrors 1910 and 1920 mounted to or formed on a circular double-wedge-shaped substrate 1900. In some embodiments, two sections of the same mirror shape are placed facing and opposite to each other, forming a single circular double-wedged mirror, as shown in FIG. 21. The dual-mirror system 1901 is rotated around the central axis 1931 of rotation. In some embodiments, the complete rotating dual-mirror system 1901 is made as a single unit, or as an assembly of two units. In some embodiments dual-mirror system 1901 is made using glass, metal, or other suitable material, and with the reflective surfaces polished and coated to be highly reflective. In some embodiments dual-mirror system 1901 is made using die casting, or electro-forming, such that dual-mirror system 1901 is made as a single unit with mounting features included.

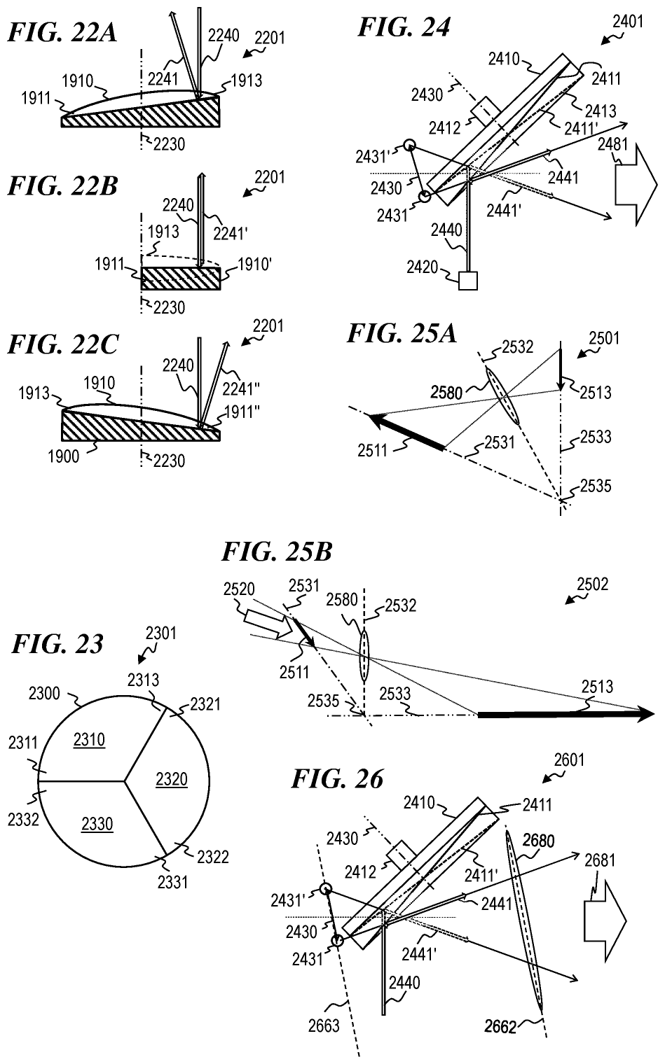

FIG. 22A is a perspective cross-section view of wedged mirror 1910 of rotating-dual-mirror system 2201 in a first rotational orientation.

FIG. 22B is a perspective cross-section view of wedged mirror 1910 of rotating-dual-mirror system 2201 in a second rotational orientation.

FIG. 22A is a perspective cross-section view of wedged mirror 1910 of rotating-dual-mirror system 2201 in a third rotational orientation.

FIGS. 22A, 22B and 22C show three cross-sectional views of wedged mirror half 1910 of circular double-wedged mirror 1901 in three positions of the wedge mirror 1910—in the 0°, 90°, and 180° positions. At the 0° position of FIG. 22A, a vertical-angle input beam 2240, which in various embodiments includes one or more laser beams, and/or one or more white-light LED beams, will be reflected upward as output beam 2241 toward the left side of system 2201, as shown. When the wedged mirror 1910 is rotated to the 90° position of FIG. 22B, vertical-angle input beam 2240 will be reflected vertically upward as output beam 2241′, since mirror 1910 at the 90° position is perpendicular to input beam 2240. As the wedged prism is rotated to the 180° position of FIG. 22C, vertical-angle input beam 2240 will be reflected vertically upward as output beam 2241″, reflected upward to the right. As the wedge mirror 1901 is rotating, output beam 2241 will be reflected from one side to the other, and as the input beam jumps from one wedge 1910 to the other wedge 1920, the output beam 2241 will also jump from the end of the scan line back to the start of the scan-line scanning position. The circular double-wedged mirror system 1901 as shown in FIG. 21 will produce two scans for each revolution.

FIG. 23 is a top view of a rotating-triple-mirror system 2301 that includes three semi-circular planar mirrors 2310, 2320, and 2330 mounted to or formed on a circular triple-wedge-shaped substrate 2300, according to some embodiments of the present invention. In some embodiments, rotating-triple-mirror system 2301 includes three wedged mirrors, each of which occupies 120°, allowing three sets of wedged mirrors to be combined into a single circular mirror. This will produce three scans in one revolution, allowing a slower rotation speed to achieve a given scanning rate. In general, and as implemented in various embodiments, three or more segments of wedged mirrors are used, producing three or more scans per revolution.

FIG. 24 is an elevational side view of a rotating circular double-wedged mirror system 2401 with rotating mirror 2411, mounted on a wedge-spacer 2410 that is rotated by motor 2412, when the first wedged mirror 2411 is in a first orientation (indicated by 2411) and in a second orientation (indicated by dashed-line 2411′, which also represents the second wedged mirror 2412) relative to first input beam 2440, according to some embodiments of the present invention. FIG. 24 shows a circular double-wedged mirror scanning system 2410, such as system 1901 of FIG. 21, used with a light source 2420, such as an LED source, a laser-excited-phosphor source, or the like, such that the output 2481 can be scanned by the rotating wedge mirrors. In the embodiment shown, the rotation axis 2430 is placed at 45 degrees from propagation direction of beam 2440 from single input light source 2420 such that, nominally, the scanning output beam 2441 will be reflected by 90 degrees to be output light 2481. The input beam 2440 from light source 2420 is directed to both wedged mirror 2411 and wedged mirror 2413 as the double-wedged mirrors are rotating. When light beam 2440 is reflected by the high-level sides of the two mirrors 2411 and 2413 (which is shown superimposed on the line labeled 2411′, representing a position of mirror 2411 when rotated) 180°, the output is in the direction of reflection 2441. When light beam 2440 is reflected by the respective low-level sides of the two mirrors 2411 and 2413 as they rotate to successive positions, the output is in the direction of reflection 2441′. As mirrors 2411 and 2413 are rotating, output beam 2481 will be scanned between angular directions 2441 and 2441′. In some embodiments, output beam 2481 is then projected to the roadway or screen using a projection lens (not shown here, but see lens 2580 of FIG. 25B). Considering the reflections from both the high-level and low-level sides of the mirrors, the images of the light source have different optical distances and would not produce a focused image using a traditional projection system using a projection lens perpendicular to the horizontal position.

In general, and as implemented in various embodiments, two or more input light sources 2440 can be stacked (e.g., such as using two or more parallel input laser beams impinging on the circular double-wedged mirror scanning system of FIG. 21), producing even more scanning output beams. In some embodiments, this approach of using a plurality of parallel input laser beams impinging on a rotating wedged mirror system is also applied to rotating wedged-mirror systems using three or more wedged mirror segments.

FIG. 25A is a side view of a system 2501 that obeys the Scheimpflug principle (e.g., see Wikipedia en.wikipedia.org/wiki/Scheimpflug_principle), wherein the object plane 2531, the lens plane 2532 and the image plane 2533 all intersect at a single line 2535 (only the end of which shows in FIG. 25A), according to some embodiments of the present invention. In some embodiments, as shown in FIG. 25A, when the object or subject 2511 (which is to be projected to image 2513, which, in some embodiments, represents scanning light source 2430 between 2431 and 2431″ as shown in FIG. 24) is tilted to plane 2531, projection lens 2580 is tilted to plane 2532 that is oriented to correct the focusing disparities introduced by the tilt of the subject 2511 relative to the image plane 2533. Considering the planes 2531, 2532, and 2533 of the subject 2511, the lens 2580, and the image 2513, respectively, all these planes should intersect at the same line 2535 in space, as shown. Under this “Scheimpflug” condition, the image 2513 will be focused.

FIG. 25B is a side view of a system 2502 that also obeys the Scheimpflug principle, according to some embodiments of the present invention. In this configuration, system 2502 includes a source of illumination 2520 characterized by the source-illumination object or subject 2511 being in plane 2531, the lens 2580 is in the vertical plane 2532, and the image 2513 (e.g., in some embodiments, the headlight beam on a roadway) is on the horizontal plane 2533. This configuration is designed for automotive uses such that the intersection of the three planes 2531, 2532 and 2533 all at line 2535 (again, only the end of which shows in FIG. 25B) provides that image 2513 (the headlight beam) is in focus from its near-to-vehicle left end to its furthest-from-vehicle right-hand end in FIG. 25B.

FIG. 26 is a front-elevational side view of rotating-mirror system 2601 with rotating mirror 2411, mounted on a wedge-spacer 2410 that is rotated by motor 2412, when mirror 2411 is in a first orientation (indicated by 2411) and in a second orientation (indicated by 2411′) relative to first input beam 1140, according to some embodiments of the present invention. Applying the same “Scheimpflug” principle, when applied in FIG. 26, assuming that the image of the light source will be projected to a long distance, the image plane can be considered as vertical for the entire scan to be in focus at that plane (not shown in FIG. 26, since it would be far to the right of FIG. 26). In this case, the three planes will meet at a considerable distance (e.g., infinity). As a result, in some embodiments, the plane 2662 of projection lens 2680 and the light-source plane 2663 will be parallel, and meet the image plane (not shown) at infinity downward. If one considers imaging the light at a plane closer than infinity, such as 25 meters for a standard-system test, the angles of the light-source plane 2663 and lens plane 2662 are angled accordingly such that they both intersect the image plane at the same single line (e.g., see FIG. 25B described above).

In some embodiments, the light source includes an array of LEDs in one dimension (along a line) or in two dimensions (in a plane), such that the output beam 2681 will have more than one output component, with the plurality of scanning-beam components from the multiple beams, increasing the brightness and pattern capabilities of the system.

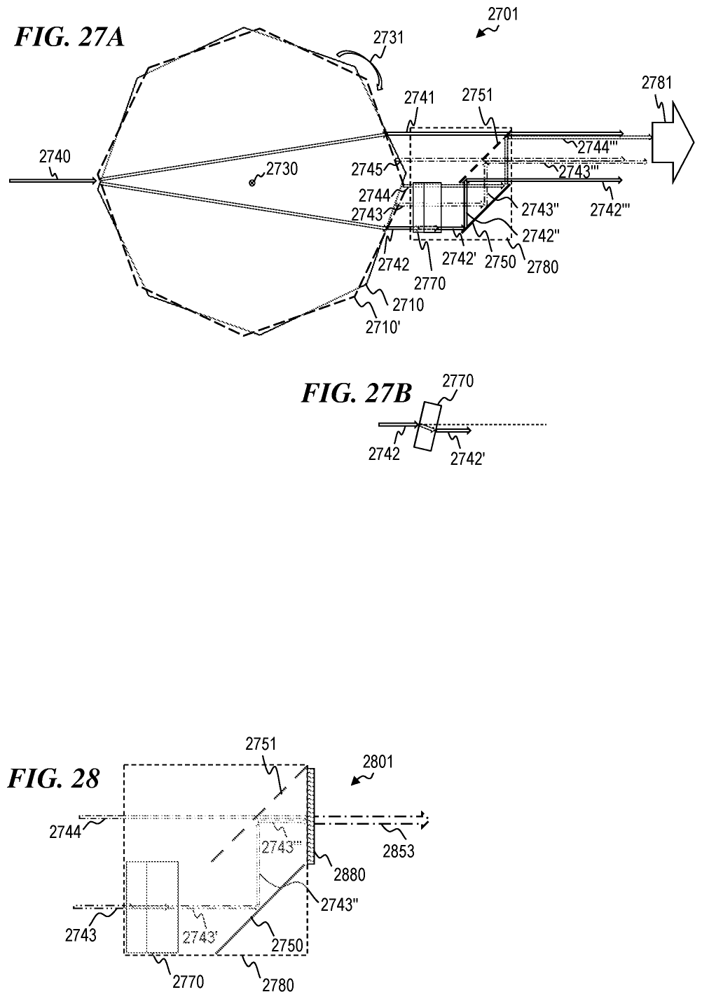

FIGS. 27A and 27B show a rotating octagonal-transparent-prism system 2701. FIG. 27A is a top view of rotating octagonal-transparent-prism system 2701 with a rotating octagonal-top rectangular-sided transparent prism 2710 in a first orientation (indicated as 2710) and in a second orientation (indicated as 2710′) relative to first input beam 2740, and further including a rectangular beam-shifting prism (such as a glass plate 2770 having parallel faces) and a mirror-prism-slotted mirror subsystem 2780, according to some embodiments of the present invention.

FIG. 27B a side view of rectangular beam-shifting prism 2770 of system 2701. FIG. 27A shows an embodiment where the full extent of the scanned line can be folded, producing twice as many lines at half the scanned width. As shown in FIGS. 27A and 27B, half of the scan line is shifted vertically in position using a glass plate 2770. The amount of shift can be determined by the thickness and tilt angle of the glass plate 2770, and is preferably adjusted such that the shifted lines (2742′, and the like, in FIG. 27A) are in between the original lines 2741, 2745 and the like), interlacing between them. The shifted set of lines 2744′″, 2743′″, and 2742′″ will then be reflected by a flat mirror 2750 towards the other half of the lines. These two sets of lines are then combined using a slotted mirror 2751 in which the shifted line will be reflected again towards the direction of output beam 2781 and the unshifted lines 2741, 2745 etc., will pass through the slots in the slotted mirror 2751 towards the output beam 2781. The resulting output beam 2781 has twice the number of lines with half the scanned width.

FIG. 28 is a top view of a mirror-prism-slotted-mirror and phosphor-plate system 2801, which adds phosphor plate 2880 to mirror-prism-slotted mirror subsystem 2780 (as shown in FIG. 27A), according to some embodiments of the present invention. FIG. 28 shows an arrangement where the complete assembly is integrated into a single component system 2801 with the tilted glass plate 2770, the flat mirror 2750, the slotted mirror 2751, and the phosphor plate 2880 mounted together. In some embodiments, this single component 2801 is placed at the output of a rotating prism system (such as those described above) or a rotating mirror system (such as those described below), producing a scanned phosphor wavelength-converted light output. For certain desired light-output patterns, the laser is modulated with a digitally transformed mapping of the output pattern back to the input pattern with the folding considered.

In general, and as implemented in various embodiments, the output can be folded three times or more such that successive scan lines from a single rotation of the prism lie on top of one another. For example, when folded three times, by dividing the scanning line in thirds, shifting them between the original lines also in thirds, and reflecting and combining them in two separate flat mirrors and two separate slotted mirrors. In addition, in some embodiments one or more units of these systems are used in a cascade arrangement, producing more lines—such as two times, three times, 2×2 times, 2×3 times, etc. —with corresponding reductions in line widths. This allows the use of a single rotation prism with a smaller number of sides and produces a greater number of scanned lines for higher-resolution systems.

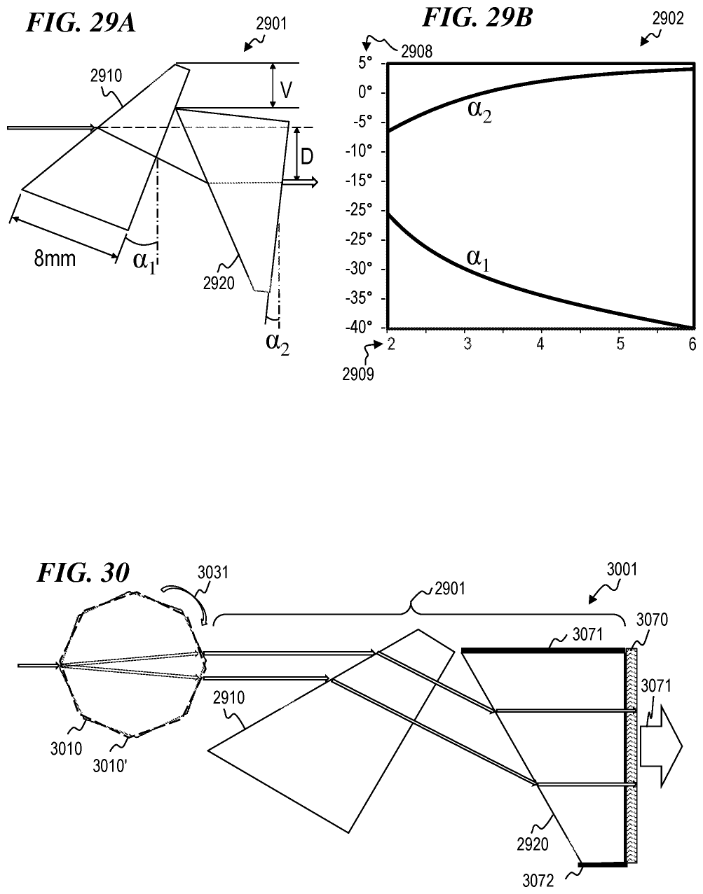

FIG. 29A a side view of an anamorphic-prism-pair system 2901 that can increase the width in one direction such that a greater number of lines with wider widths can be obtained simultaneously, according to some embodiments of the present invention. In some embodiments, anamorphic-prism-pair system 2901 includes a first prism 2910 at a first angle α₁ that refracts the light downward and spreads the beam, and a second prism 2920 at a second angle α₂, that refracts the light back and stops the spreading at a desired width.

FIG. 29B is a graph 2902 of the amount of vertical magnification versus prism angles of anamorphic-prism-pair system 2901, according to some embodiments of the present invention. After the number of lines is increased with the reduction of line width (such as described above for FIGS. 27A and 28, the embodiment of FIG. 29A shows an anamorphic prism pair that can increase the width in one direction such that a greater number of lines with wider widths can be obtained simultaneously. In this embodiment, system 2901 includes two triangular prisms 2910 and 2920, placed as shown, such that the amount of width increase is controlled by the positioning of the prisms and determined by the two angles α₁ and α₂. The graph 2902 shows the combinations of these two angles, the lower graph line representing α₁ and the upper graph line representing α₂, producing a magnification in a range of two to six.

FIG. 30 is a top view of a rotating octagonal-transparent-prism system 3001 with a rotating octagonal-top rectangular-sided transparent prism 3010 in a first orientation (solid-line outline) and a second orientation 3010′ (the slightly angularly offset dashed-line outline) relative to first input beam 3040, and further including an anamorphic-prism-pair system 2901 and a phosphor plate 3070, according to some embodiments of the present invention. FIG. 30 shows the embodiment of integrating the rotating prism 3010, together with the anamorphic-prism pair 2901, widening the scanned phosphor-emission output lines 3071 of the system 3001. In another embodiment, not shown, the systems as described in FIG. 27A and FIG. 28 are inserted between the rotation prism 3010 and the anamorphic-prism pair 2901, as a complete system for increasing the number of scanned lines and the width of the lines.

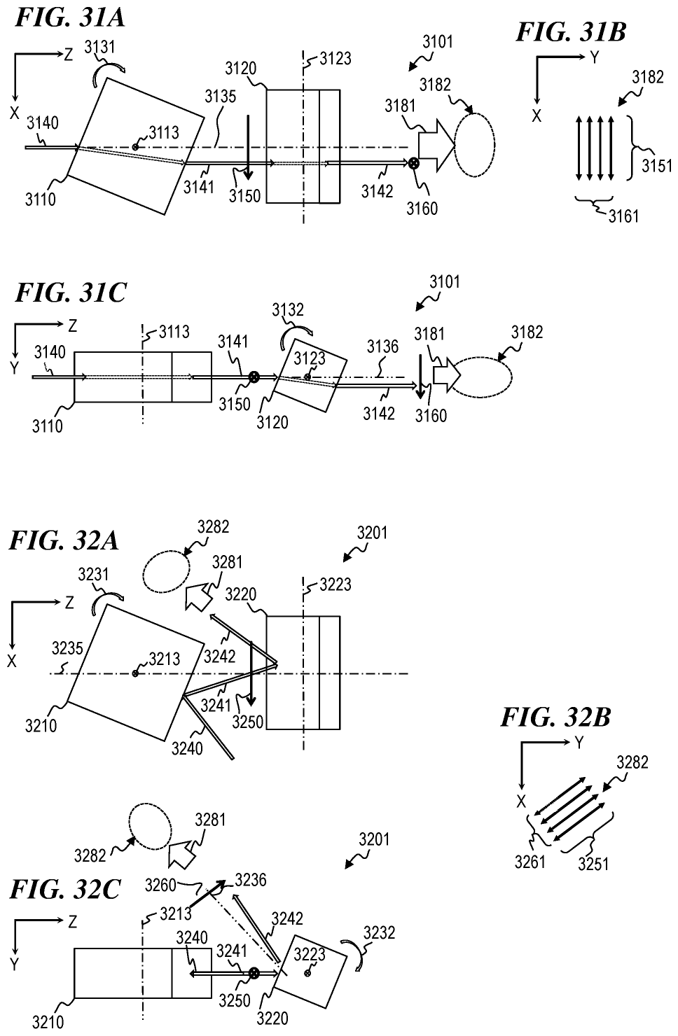

FIG. 31A is a top view of a dual rotating square-transparent-prism system 3101 with a rotating square-top rectangular-sided transparent prism 3110 in a first orientation relative to first input beam 3140, and further including a second rotating square-top rectangular-sided transparent prism 3120, according to some embodiments of the present invention.

FIG. 31B is a front view of a resulting pattern of scan lines 3182 generated by dual rotating square-transparent-prism system 3101, according to some embodiments of the present invention.

FIG. 31C is a side view of dual rotating square-transparent-prism system 3101.

In some other embodiments (not shown), prism 3110 and/or prism 3120 are tilted (as shown in FIG. 11 and/or FIG. 18) such that additional scan lines are formed.

FIGS. 31A and 31C show another scanning laser system 3101 that scans in two dimensions 3150 and 3160 using two rotation prisms 3110 and 3120. In some embodiments, two square prisms 3110 and 3120 are used. In other embodiments (not shown), prisms with more sides are used, as may be required. The X-rotating prism 3110 rotates around axis 3113, as shown, to produce a scan line 3150 in the X-direction. The output beam 3141 is directed toward Y-rotating prism 3120 in which the scanned lines are shifted in the Y-direction (in the 3160 direction), producing a raster scanned pattern 3182 (see FIG. 31B) at the output beam 3181. The different relative rotating speeds of prisms 3110 and 3120 determines the number of lines in pattern 3182. For example, if the X-rotating prism 3110 has a rotational speed of 20,000 rotations per second and the Y-rotating prism 3120 has a rotational speed of 100 rotations per second, the number of lines will be 20,000/100=200 lines with 100 frames per second. As a result, the number of lines and frames per second can be controlled by the rotation speeds of the motors that rotate prisms 3110 and 3120, providing flexibility for the system.

FIG. 32A is a top view of a dual rotating polygonal-mirror system 3201 with a rotating square-polygon mirror 3210 in a first orientation relative to first input beam 3240, and further including a second rotating square-polygon mirror 3220, according to some embodiments of the present invention.

FIG. 32B is a front view of a resulting pattern of scan lines 3382 generated by dual rotating polygonal-mirror system 3201, according to some embodiments of the present invention.

FIG. 32C is a side view of dual rotating polygonal-mirror system 3201. In some embodiments, laser beam 3240 is scanned using polygon mirror scanners, as shown in FIGS. 32A and 32C, wherein two rotating polygon mirror scanners 3210 and 3220 are placed with their rotational axes orthogonal to each other, producing raster-scan pattern 3282 as shown in the FIG. 32B. In this example, four-mirror polygons are used. Similar to that as shown in FIG. 31, the number of lines and frames per second can be controlled by the speed of the motors that rotate mirror systems 3210 and 3220.

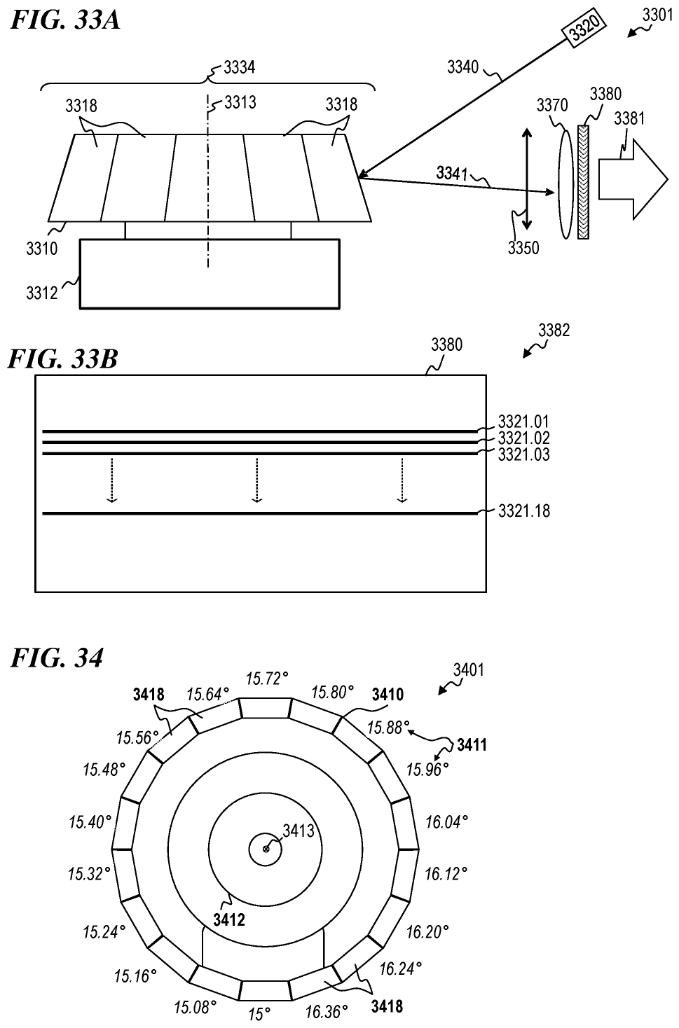

FIG. 33A is a side view block diagram of a rotating multi-faceted-mirror system 3301 with a rotating multi-faceted-mirror system 3334 (which, in some embodiments, uses rotating multi-faceted-mirror system 3401 as shown in FIG. 34) with a rotating multi-faceted mirror 3310 in a first orientation relative to first input beam 3340 generated from laser source 3320, according to some embodiments of the present invention. In some embodiments, multi-faceted mirror 3310 has a plurality of mirrors 3318 (e.g., in some embodiments, eighteen (18) mirrors), each tilted at a different angle to rotational axis 3313 so as to produce a plurality of different reflection angles for the scan lines when motor 3312 rotates multi-faceted mirror 3310.

FIG. 33B is a front view of a resulting pattern of scan lines 3382 generated by dual rotating polygonal-mirror system 3101, according to some embodiments of the present invention. FIGS. 33A and 33B show an embodiment where a multi-faceted polygon-mirror scanner 3310 rotated by motor 3312 reflects an input laser beam 3340 as scanning beam 3341 to produce a pattern 3382 having multiple scan lines 3321.01, 3321.02, 3321.03 . . . through 3321.18. In some embodiments, the laser beam 3340 with its focus adjusted (by laser 3320's internal optics and/or lens 3370) at the phosphor plate is directed towards the polygon scanner. Each facet 3318 of the scanner 3334 with its multi-faceted-mirror 3310 and motor 3312 is designed to have a different tilt angle for each mirror 3318 relative to rotational axis 3313 such that the scanned laser line 3341 produced by each facet 3318 will have a different output angle (tilted up/down as shown by double arrow 3350), thus scanning the full area of the phosphor plate 3380. In some embodiments an optional collimating lens 3370 is placed before the phosphor plate 3380, such that the output beam direction from lens 3370 is made perpendicular to the front surface of phosphor plate 3380.

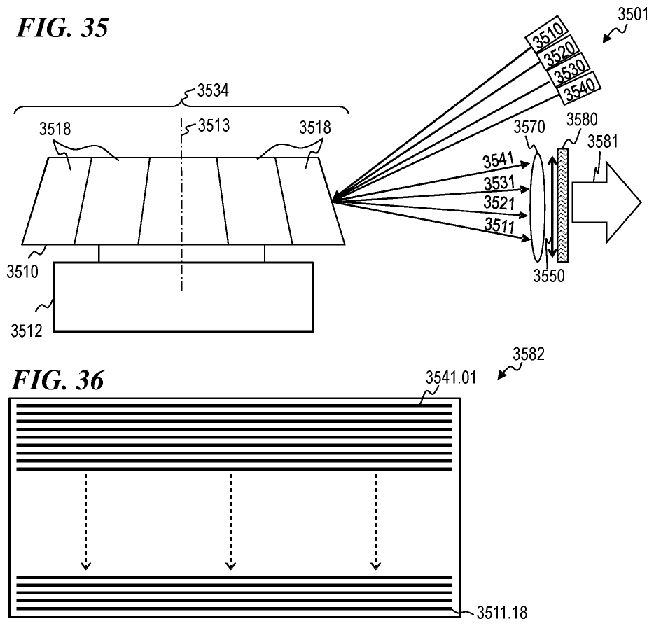

FIG. 34 is a top view of a rotating multi-faceted-mirror system 3401 with a rotating multi-faceted polygon mirror 3410, according to some embodiments of the present invention. As shown in FIG. 34, in some embodiments, multi-faceted polygon mirror 3410 has eighteen (18) facets 3418, each having a respective tilted mirror face oriented at eighteen different angles relative to rotational axis 3413. In some embodiments, the eighteen different angles are 15°, 15.08°, 15.16°, 15.24°, 15.32°, 15.4°, 15.48°, 15.56°, 15.64°, 15.72°, 15.8°, 15.88°, 15.96°, 16.04°, 16.12°, 16.2°, 16.28°, and 16.36°. Other embodiments can use different angles. In some embodiments, multi-faceted polygon mirror system 3401 is used for rotating optical system 3334 in system 3301 of FIG. 33A, and the output pattern shown in FIG. 33B will have eighteen scanned lines. In some embodiments, to produce a larger number of lines, a plurality of lasers is used. In some embodiments, multi-faceted polygon mirror system 3401 is used for rotating optical system 3534 in system 3501 of FIG. 35A, four lasers 3510, 3520, 3530 and 3540 are used, and the output pattern 3582 shown in FIG. 36 will have seventy-two scanned lines.

FIG. 35 is a side view block diagram of a rotating multi-faceted-mirror system 3501 with a rotating multi-faceted-mirror system 3534 (which, in some embodiments, uses rotating multi-faceted-mirror system 3401) that includes rotating multi-faceted mirror system 3510 (which is rotated around rotational axis 3513 by motor 3512). Multi-faceted-mirror system 3534 is shown in a first orientation relative to a plurality of input laser beams generated from laser sources 3510, 3520, 3530, and 3540, according to some embodiments of the present invention. In some embodiments, multi-faceted mirror 3510 includes eighteen mirrored facets 3518, each at a different angle to the rotational axis 3513. In some embodiments, multi-faceted-mirror system 3501 includes four lasers, 3510, 3520, 3530, and 3540 as shown. In some embodiments, each of the lasers 3510, 3520, 3539, and 3540 includes a laser diode and a focusing lens. Lasers 3510, 3520, 3530 and 3540 have their beams directed towards the polygon mirrored facets 3518 at different angles such that four scanned lines 3541, 3531, 3521 and 3511 are reflected at different angles by each mirrored facet 3518 of the polygon multi-faceted mirror 3510. In some embodiments, the angles between the laser beam propagation-axes lasers, 3510, 3520, 3530, and 3540 and the different tilting angles of each mirrored facet 3518 of the polygon multi-faceted mirror 3510 are adjusted such that the lines on the phosphor plate 3550 are equally spaced or spaced to form a certain pattern, as desired.

FIG. 36 is a front enlarged view of a plurality of scan lines 3582 on phosphor plate 3580 produced by rotating multi-faceted mirror 3510 and reflecting the plurality of input beams from lasers 3510, 3520, 3530 and 3540. FIG. 36 shows the output of example system 3501 with four lasers 3510, 3520, 3530 and 3540 and eighteen-facet mirror 3510. In some embodiments a larger number of scanned lines (e.g., scan line 3541.01 for the uppermost reflection of the uppermost scanning laser beam 3541, through scan line 3511.18 for the lowermost reflection of the lowermost scanning laser beam 3511) is produced using a greater number of lasers and/or a greater number of facets 3518 of the polygon multi-faceted mirror 3510.

FIG. 37 is a side-view block diagram of a rotating multi-faceted-mirror system 3701 with three rotating multi-faceted mirror systems 3738, 3739, and 3740, all rotated by the same motor 3712, and usable to simultaneously generate a headlight beam 3890, a scanning LiDAR beam 3990 and provide input for a scanning LiDAR receiver (such as detector 4080 shown in FIG. 40 and associated controller and calculation hardware 4295 and 4290 such as shown in block diagram form in FIG. 42) for receiving reflected LiDAR signals 4090, according to some embodiments of the present invention. FIG. 37 shows an embodiment where the smart headlight and the LiDAR output and LiDAR sensor are integrated into a single unit using the same motor 3712. As shown in FIG. 37, some embodiments include the headlight scanner using mirror system 3738 placed on the top, the LiDAR laser output scanner using mirror system 3739 is placed in the middle layer, and the LiDAR detector scanner using mirror system 3740 is placed at the bottom. Each pair 3738-3739 and 3739-3740 is separated from one another by a light shield 3714, so that they do not interfere with each other. In various other embodiments (not shown), the three scanners 3738, 3739, and 3740 can also be rearranged per system requirements. For example, in some embodiments the laser output scanner 3739 is on the top and the headlight scanner 3738 is at the bottom.

FIG. 38 is a top view of a rotating multi-faceted-mirror headlight system 3801 with a rotating multi-faceted mirror system 3811 shown in three positions labeled 3811, 3811′ and 3811″, a phosphor plate 3880 and a system of one or more optional collimation and projection lenses 3870, and 3872, according to some embodiments of the present invention. FIG. 38 shows an embodiment where the scanner is an eight-sided polygon, with eight tilted mirrors 3808 at eight different angles. The tilting angle of each mirror facet 3808, and the number of mirror facets 3808, can be designed such that multiple scan lines can be produced from the plurality of mirror facets at different angles. In this case, a total of eight scan lines are produced from the input laser beam 3840 for each full rotation of rotating multi-faceted mirror system 3811, if the eight mirrors 3808 are tilted at eight different angles. In some embodiments the output is then used to excite the phosphor plate 3880 through a field lens 3870 with the desired illumination pattern, and the output visible light 3890 is projected onto the roadway using projection lens 3872. In various embodiments, polygons with different numbers of sides are used, for generating different numbers of lines. In some embodiments, a plurality of scan lines on top of one another are scanned using a subset of the plurality of mirrors 3808 that have the same tilt angle, for increased intensity at certain lines of the output beam 3890, as required.

FIG. 39 is a top view of a rotating multi-faceted-mirror system 3901 with rotating multi-faceted mirrors 3911 shown in three positions labeled 3911, 3911′ and 3911″, according to some embodiments of the present invention. FIG. 39 shows an embodiment of the IR laser-beam scanner usable for outputting a scanning pulsed LiDAR signal. An example embodiment is shown in FIG. 39, with eight tilted mirrors 3908 at eight different angles, one of which is on each side. Similarly, depending on the number of IR-laser-beam LiDAR scan lines required in various embodiments, the number of mirrors is changed and the mirrors are tilted accordingly. According to the angle of rotation of the polygon and the tilting of the mirror, the direction of the laser beam target can be determined in terms of vertical angle and horizontal angle. The LiDAR signal will then be reflected by the target and be detected by the detection system, as shown in FIG. 40. In some embodiments, laser beam 3990 is from a pulsed laser, where the return pulse 4090 is detected and the distance is calculated by the time-of-flight (ToF) between the sending of the outgoing pulse and the receiving of the reflected pulse. With the output scanning laser beam 3990 and multiple pulses, a three-dimensional (3D) image or picture of the scanned area can be constructed digitally. In other embodiments, the laser beam 3990 is a continuous-wave (CW) laser beam, wherein the beam is frequency modulated (FMCW). The reflected received beam 4090 is optically combined with a portion of the output beam where the phase difference between the two beams is measured. In some embodiments, the distance is calculated by the phase difference between the output beam and the reflected received beam. Again, the 3D image or picture of the scanned area is constructed digitally. The lasers used to generate beam 3940 can be an Edge Emitting Laser (EEL), DFB Laser, Vertical Cavity Surface Emitting Laser (VCSEL), Photonic Crystal Surface Emitting Laser (PCSEL), etc. For higher power operations, multiple units of these lasers can be configured in one-dimensional or two-dimensional arrays. Appropriate lenses are used to collimate the output beams as required. The wavelength of the lasers can be selected from a range of about 900 nm to about 1,550 nm. The longer wavelengths lasers are considered to be more eye-safe and are preferred for some embodiments, but perhaps at higher cost.

FIG. 40 is a bottom view of a rotating multi-faceted-mirror system 4001 with rotating multi-faceted mirrors 4011 shown in three positions labeled 4011, 4011′ and 4011″, a line sensor (or detector) 4080 and a system of one or more optional collimation or focussing lenses 4070, according to some embodiments of the present invention. FIG. 40 shows the embodiment of a detection system with an eight-sided polygon scanner with eight tilted mirrors 4008 at eight different angles, one of which is on each side of the polygon. The tilting of the mirrors 4008 has the same angles as the laser scanner polygon 3901 of FIG. 39 and is synchronized such that the reflected signal 4090 from the laser-beam target is reflected into detector system 4081, by one of the tilted mirrors 4008, and focused onto the detector 4080. Since the laser-scanning and the detector-scanning polygons are synchronized, the reflected laser light from each point on the target will be reflected back and focused back into a single point where the detector 4080 is located (thus the spot of interest will have a relatively higher intensity), while light from other directions is not focused on detector 4080 (thus having relatively lower intensity). When the incoming beam 4090 includes the scanned beam coming from solid-line-arrow directions 4040 to 4040′, the rotating multi-faceted mirrors will be in the position marked 4011, and thus will be reflected as solid-line-arrow vertical beams 4041 to 4041′. Similarly, when the incoming beam 4090 includes the scanned beam coming from long-dashed-line-arrow directions 4043 to 4043′, the rotating multi-faceted mirrors will be in the position marked 4011′, and thus will be reflected as long-dashed-line-arrow vertical beams 4044 to 4044′, and when the incoming beam 4090 includes the scanned beam coming from short-dashed-line-arrow vertical directions 4042 to 4042′, the rotating multi-faceted mirrors will be in the position marked 4011″, and thus will be reflected as short-dashed-line-arrow vertical beams (not labeled). In some embodiments, a lens 4070 is used to focus the vertical beams 4041-4041′ through 4044-4044′ to detector array 4080, and optionally includes a shade 4071. In a LiDAR system operation, the location of the target is determined by the vertical and horizontal angles of the outgoing laser beam and its reflected signal, and the time delay between the output pulse from rotating multi-faceted-mirror system 3901 and the detected light pulse received by rotating multi-faceted-mirror system 4001. The distance to each target object is determined by the out-and-back time-of-flight—the time between the generated laser pulse and the received reflected laser pulse. In some embodiments, using such distances and vertical and horizontal angles, a three-dimensional (3D) map with the field of view is generated or determined.

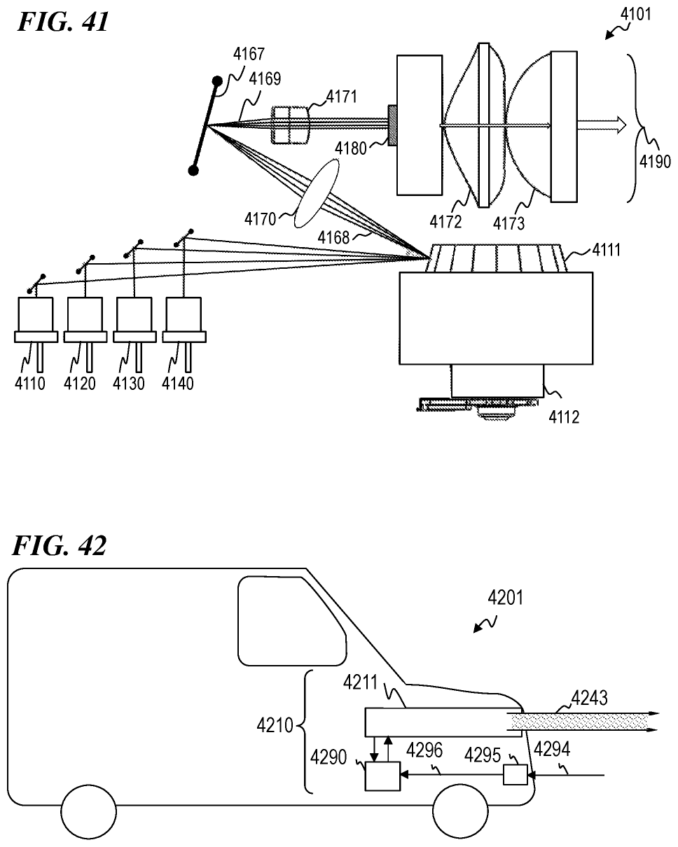

FIG. 41 is a side view of a rotating multi-faceted-mirror system 4101 with a system of rotating multi-faceted mirrors 4111 rotated by motor 4112 usable to generate a headlight beam 4190, according to some embodiments of the present invention. FIG. 41 shows an embodiment of this invention in which the right-hand edge of the projection lens 4173 of the headlight is made nearly flush with the IR-laser-beam-scanning polygon 4111 and the detector-scanning polygon (not shown here), such that the complete assembly can be package as a complete assembly and placed at the location of the headlight (e.g., such as headlight system 4211 of FIG. 42). In this case, the headlight laser diodes 4110, 4120, 4130 and 4140 are placed at the back of the assembly (the left-hand side of FIG. 41) with their beams incident at the reflective polygon 4111 (which, in some embodiments, has a plurality of reflective faces at different reflecting angles to form scan lines from the laser beam(s)). The output scanning beam 4168 is directed towards the transmissive phosphor plate 4180 through a relay lens 4170, a mirror 4168 (to form scanning beam 4169), and a focusing lens 4171. The scanning focused spots produce scan lines on the phosphor plate 4180 as moving light spots. The output from phosphor plate 4180 is then projected using lenses 4172 and 4173 onto the roadway. The laser diodes 4110, 4120, 4130 and 4140 are digitally controlled and are synchronized with the rotating polygon reflective set of mirrors 4111 such that the desired light patterns are produced.

FIG. 42 is a block diagram of a vehicle 4201 that includes a light source 4211 (such as, in some embodiments, rotating multi-faceted-mirror system 3701 (as shown in FIG. 37) with rotating multi-faceted mirror systems 3801 (as shown in FIG. 38) and 3901 (as shown in FIG. 39), all rotated by the same motor 3712, and usable to simultaneously generate a headlight beam 3890, a scanning LiDAR beam 3990 and/or provide input for a scanning LiDAR receiver for receiving reflected LiDAR signals 4090, according to some embodiments of the present invention. In some embodiments, a scene sensor 4295 is configured to actively (e.g., using a received LiDAR signal such as 4090 described for FIG. 37 and FIG. 40 above) and/or passively (using a camera or the like) receive light signals 4294 (such as reflections of LiDAR signals 3940) to sense the environment around the vehicle 4201 in which sensor 4295 and light source 4211 are housed, and the received signals or data 4294 received by sensor 4295 are processed into sensed data 4296 and operatively coupled to processor 4290, which then optionally generates a 3D map of the surrounding environment, which can be used to control operation of vehicle 4201 (such as a self-driving car or truck), detect pedestrians, other vehicles or other objects around vehicle 4201, and/or to adjust the shape, direction and/or intensity of various low-beam, high-beam and/or extreme-high-beam portions of headlight beam 4243 as described above. In some embodiments, this sensing/controlling function is optionally activatable and deactivatable by the human driver (analogous to automobile “cruise control”).

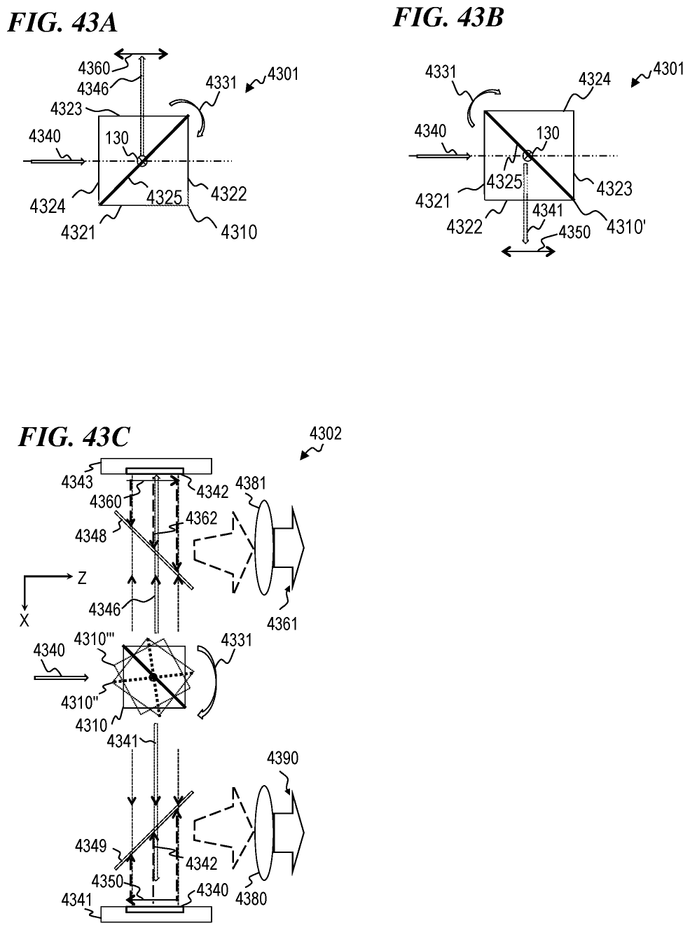

FIG. 43A is a top view of a square beam-splitter prism system 4301 with a square-top rectangular-face rotating beam-splitter prism 4310 in a first orientation relative to input beam 4340, according to some embodiments of the present invention. As shown, input beam 4340 enters face 4324 and is reflected upward by internal beam splitter 4325 for 90° of rotation of beam-splitter prism 4310, producing scan beam 4346 scanning in direction 4360 (while input beam 4340 enters face 4324 and exits face 4323).

Then, as shown in FIG. 43B, input beam 4340 enters face 4321 and is reflected downward by internal beam splitter 4325 for 90° of rotation of beam-splitter prism 4310 producing scan beam 4341 scanning in direction 4350 (while input beam 4340 enters face 4321 and exits face 4322).

FIG. 43B is a top view of square beam-splitter prism system 4301 with rotating beam-splitter prism 4310 in a second orientation (indicated as 4310′ since it is rotated 90° from the orientation of FIG. 43A) relative to input beam 4340.

Then, for the following 90° of rotation of beam-splitter prism 4310 (not shown) input beam 4340 enters face 4322 and is reflected upward by internal beam splitter 4325 for 90° of rotation of beam-splitter prism 4310, again producing scan beam 4346 scanning in direction 4360 (while input beam 4340 enters face 4322 and exits face 4321).

Then, for the following 90° of rotation of beam-splitter prism 4310 (again, not shown) input beam 4340 enters face 4323 and is reflected downward by internal beam splitter 4325 for 90° of rotation of beam-splitter prism 4310 producing scan beam 4341 scanning in direction 4350 (while input beam 4340 enters face 4323 and exits face 4324), directions again as shown in FIG. 43B. Then the whole process repeats for the next full rotation of prism 4310.

FIG. 43C is a top view of a square beam-splitter prism system 4302 with rotating beam-splitter prism 4310 in three different orientations (indicated as 4310, 4310′, 4310″) relative to input beam 4340, and a first reflective phosphor plate 4340 (with its heat sink 4341) and a second reflective phosphor plate 4342 (with its heat sink 4343), according to some embodiments of the present invention. In this embodiment, first reflective phosphor plate 4340 (which is mounted on heatsink 4341) receives the downward scanning beam 4341 scanning in the 4350 direction, and the resulting emitted light 4342 in the upward direction is reflected rightward by reflector 4349 (which can be any of the embodiments described above for reflector 349 of FIG. 3) and projected as output beam 4390 by lens 4380. Similarly, second reflective phosphor plate 4342 (which is mounted on heatsink 4343) receives the upward scan beam 4346 scanning in the 4360 direction, and the resulting emitted light 4362 in the downward direction is reflected rightward by reflector 4348 (which can be any of the embodiments described above for reflector 349 of FIG. 3) and projected as output beam 4361 by lens 4381.

In various embodiments, the beam splitter 4325 is highly reflective (to create two scanning patterns—one scanning pattern upward and one scanning pattern downward), partially reflective (to create three patterns—one straight through as in FIGS. 1B-1E) plus one scanning pattern upward and one scanning pattern downward), wavelength-selective, and/or polarized, in order to create different scanning patterns, a desired.

In some embodiments (not shown, but similar to that of FIG. 43C), beam splitter 4325 is partially reflective (as described above) to create three patterns—one straight through as in FIGS. 1B-1E and this not-shown embodiment, including a third phosphor plate such as plate 340 of FIGS. 3A, 3B and 3C and a third set of associated reflector(s) and lens(es)), plus one scanning pattern 4360 upward and one scanning pattern downward 4350 as shown here).

In some embodiments (not shown, but similar to FIGS. 11, 12, 13, 14 and 18), beam splitter 4310 is mounted on a tilted wedge and/or a plurality of parallel input beams are used to obtain a plurality of output scan lines spaced apart from one another on the scan surfaces (such as phosphor plates 4340 and 4342).

In some embodiments, the present invention provides first system having a scanned-light-beam apparatus that includes: a first source of a first light beam; a first rotary motor that has a rotational axis; and a first faceted optical device that is rotated around the rotational axis by the first motor, wherein the first faceted optical device has a plurality of faces, each of which is at one selected angle of a plurality of different angles relative to the rotational axis, and wherein the first light beam is operatively coupled to the rotated first faceted optical device to form a first plurality of spaced-apart scanned light-beam lines.

In some embodiments of the first system, the first faceted optical device includes a first multi-faceted mirror system that includes a first plurality of mirrors wherein each one of the first plurality of mirrors is tilted at a different angle relative to the rotational axis; the first light beam is a first input laser beam that is directed toward the first faceted optical device to form a first plurality of scanned laser-beam lines spaced apart from one another. This first system further includes: a phosphor plate operatively coupled to receive the first plurality of scanned laser-beam lines and to emit wavelength-converted light when stimulated by the first plurality of scanned laser-beam lines; a projection lens optically coupled to receive light emitted by the phosphor plate and to project an output headlight beam that includes the wavelength-converted light; a second multi-faceted mirror system that includes a second plurality of mirrors, wherein each one of the second plurality of mirrors is tilted at a different angle relative to the rotational axis, and wherein the second multi-faceted mirror system is rotated by the first motor; a second laser that emits a pulsed infrared (IR) laser beam that is directed toward the second multi-faceted mirror system to form a pattern of output light across a pattern of scanned directions spaced apart from one another to form a scanned pulsed output LiDAR beam; a third multi-faceted mirror system that includes a third plurality of mirrors, wherein each one of the third plurality of mirrors is tilted at a different angle relative to the rotational axis, wherein the second multi-faceted mirror system is rotated by the first motor, and wherein the third multi-faceted mirror system is configured to receive a LiDAR signal reflected from the pattern of directions of the scanned pulsed output LiDAR beam toward the third multi-faceted mirror system; a LiDAR receiver operatively coupled to receive light reflected by the third multi-faceted mirror system from the pattern of scanned directions; and a vehicle, wherein the first motor, the first laser, the first multi-faceted mirror system, the phosphor plate, the second laser, the second multi-faceted mirror system, the third multi-faceted mirror system and the LiDAR receiver are mounted to the vehicle and are used to form a headlight beam and the scanned pulsed LiDAR output beam for the vehicle. In some such embodiments, the IR laser beam includes at least one wavelength in a range of 700 nm to 1600 nm (or, in various other embodiments, in a range of 700 nm to 800 nm, in a range of 800 nm to 900 nm, in a range of 900 nm to 1000 nm, in a range of 1000 nm to 1100 nm, in a range of 1100 nm to 1200 nm, in a range of 1200 nm to 1300 nm, in a range of 1300 nm to 1400 nm, in a range of 1400 nm to 1500 nm, and/or in a range of 1500 nm to 1600 nm, or two or more of such ranges) from a pulsed IR laser and the first laser beam includes blue light having at least one wavelength in a range of 390 nm to 500 nm (or, in various other embodiments, a violet wavelength of about 405 nm, a blue wavelength of about 450 nm, or wavelengths in a range of 390 nm to 400 nm, in a range of 400 nm to 420 nm, in a range of 420 nm to 440 nm, in a range of 440 nm to 460 nm, in a range of 460 nm to 480 nm, in a range of 480 nm to 500 nm, or two or more of such ranges).

In some embodiments of the first system, the first faceted optical device includes a square prism that is tilted relative to the rotational axis such that a first pair of opposite faces is at a first angle to the rotational axis, and a second pair of opposite faces is at a second angle to the rotational axis, and the first angle is not equal to the second angle.

In some embodiments of the first system, the first faceted optical device includes a prism that has a plurality of pairs of parallel faces opposite each other relative to the rotational axis, wherein each pair of parallel faces is oriented at a different angle relative to the rotational axis.

In some embodiments of the first system, the first faceted optical device includes a multi-faceted mirror that includes a first plurality of mirrors, wherein each one of the first plurality of mirrors is tilted at a different angle relative to the rotational axis.

In some embodiments of the first system, the first light beam is a first input laser beam directed toward the first faceted optical device to form a first plurality of scanned laser-beam lines spaced apart from one another, wherein the apparatus further comprises a second source of a second input laser beam directed toward the first faceted optical device, and wherein the second laser beam is coupled to the first faceted optical device to form a second plurality of scanned laser-beam lines spaced apart from one another and from the first plurality of scanned laser-beam lines.

In some embodiments of the first system, the first light beam is a first input blue-light laser beam directed toward the first faceted optical device to form a first plurality of scanned blue-light laser-beam lines spaced apart from one another, wherein the apparatus further includes: a phosphor plate operatively coupled to receive the first plurality of scanned blue-light laser-beam lines and to emit wavelength-converted light when stimulated by the first plurality of scanned blue-light laser-beam lines; and a projection lens optically coupled to receive light emitted by the phosphor plate and to project an output beam that includes the wavelength-converted light.

In some embodiments of the first system, the first light beam is a first input laser beam that includes at least one wavelength in a range of 390 nm to 500 nm from a first laser and that is directed toward the first faceted optical device to form a first plurality of scanned laser-beam lines spaced apart from one another, and wherein the apparatus further comprises: a phosphor plate operatively coupled to receive the first plurality of scanned laser-beam lines and to emit wavelength-converted light when stimulated by the first plurality of scanned laser-beam lines; a projection lens optically coupled to receive light emitted by the phosphor plate and to project an output beam that includes the wavelength-converted light; and a vehicle, wherein the first motor, the first laser, the rotated first faceted optical device, the phosphor plate and the projection lens mounted to the vehicle and are used to form a headlight beam for the vehicle.

In some embodiments of the first system, the first faceted optical device includes a first multi-faceted mirror system that includes a first plurality of mirrors, wherein each one of the first plurality of mirrors is tilted at a different angle relative to the rotational axis; the first light beam is a first input laser beam that includes at least one wavelength in a range of 390 nm to 500 nm from a first laser and that is directed toward the first faceted optical device to form a first plurality of scanned laser-beam lines spaced apart from one another, and the apparatus further includes: a phosphor plate operatively coupled to receive the first plurality of scanned laser-beam lines and to emit wavelength-converted light when stimulated by the first plurality of scanned laser-beam lines; a projection lens optically coupled to receive light emitted by the phosphor plate and to project an output beam that includes the wavelength-converted light; and a vehicle, wherein the first motor, the first laser, the rotated first multi-faceted mirror system, the phosphor plate and the projection lens mounted to the vehicle and are used to form a headlight beam for the vehicle.

In some embodiments of the first system, the first faceted optical device includes a first multi-faceted mirror system that includes a first plurality of mirrors, wherein each one of the first plurality of mirrors is tilted at a different angle relative to the rotational axis; the first light beam is a first input infrared (IR) laser beam that optionally includes at least one wavelength in a range of 700 nm to 1500 nm from a first pulsed IR laser and that is directed toward the first faceted optical device to form a pattern of output light across a first plurality of scanned lines spaced apart from one another, and the apparatus further includes: a vehicle, wherein the first motor, the IR laser and the rotated first multi-faceted mirror system are mounted to the vehicle and are used to form a scanned pulsed LiDAR output beam for the vehicle.

In some embodiments of the first system, the first faceted optical device includes a first multi-faceted mirror system that includes a first plurality of mirrors, wherein each one of the first plurality of mirrors is tilted at a different angle relative to the rotational axis; the first light beam is a received LiDAR signal reflected from a LiDAR beam that optionally includes at least one wavelength in a range of 700 nm to 1500 nm from a pulsed IR laser and that is received toward the first faceted optical device from a pattern of scanned-line directions spaced apart from one another, and the apparatus further includes: a LiDAR receiver operatively coupled to receive light reflected by the first faceted optical device from the pattern of scanned-line directions; and a vehicle, wherein the first motor, the IR laser and the rotated first multi-faceted mirror system are mounted to the vehicle and are used to form a scanned pulsed LiDAR output beam for the vehicle.

In some embodiments of the first system, the first faceted optical device includes a square prism.

In some embodiments of the first system, the first faceted optical device includes a first square prism, the first light beam is a first laser beam and the apparatus further includes: a second motor; and a second square prism that is rotated by the second motor, wherein the first plurality of spaced-apart scanned light-beam lines from the first square prism are directed through the second prism to form a second plurality of spaced-apart scanned laser-beam lines.

In some embodiments of the first system, the first faceted optical device includes a square polygon having four mirror faces.

In some embodiments of the first system, the first faceted optical device includes a square polygon having four mirror faces, the first light beam is a first laser beam and the apparatus further includes a second motor; and a second square polygon having four mirror faces that is rotated by the second motor, wherein the first plurality of spaced-apart scanned light-beam lines reflected from the first square polygon are directed towards the second prism and reflected to form a second plurality of spaced-apart scanned laser-beam lines.

In some embodiments, the present invention provides second system having a scanned-light-beam apparatus that includes: a laser that outputs a first input laser beam; a first rotary motor; a first rotating prism driven by the first motor, wherein the first rotating prism has a plurality of pairs of input/output faces, and wherein the input laser beam is coupled through the first rotating prism to form a first scanned laser-beam line; a second rotary motor; and a second rotating prism driven by the second motor, wherein the second rotating prism has a plurality of pairs of input/output faces, and wherein the first scanned laser-beam line is coupled through the second rotating prism to form a plurality of scanned laser-beam lines parallel to one another.

In some embodiments, the present invention provides third system having a scanned-light-beam apparatus that includes: a laser that outputs a first input laser beam; a first rotating mirror assembly driven by a first motor, wherein the first rotating mirror assembly has a plurality of faces, and wherein the input laser beam is reflected by the first rotating mirror assembly to form a first scanned laser-beam line; and a second rotating mirror assembly driven by a second motor, wherein the second rotating mirror assembly has a plurality of faces, and wherein the first scanned laser-beam line is reflected by the second rotating mirror assembly to form a plurality of scanned laser-beam lines parallel to one another.

In some embodiments, the present invention provides fourth system having a scanned-light-beam apparatus that includes: a first laser that generates a first input laser beam; a first motor that has an axis of rotation; a first mirror assembly rotated by the first motor around the axis of rotation, wherein the first rotating mirror assembly has a plurality of faces each at a different angle to the axis of rotation, and wherein the first input laser beam is coupled to the first rotating mirror assembly to form a plurality of scanned laser-beam lines parallel to one another.

Some embodiments of the fourth system further include a phosphor plate, wherein the plurality of scanned laser-beam lines is projected onto the phosphor plate. In some such embodiments, the phosphor plate has a curved face configured such that the scanned laser-beam lines remain in focus across the curved face of the phosphor plate, and the phosphor plate is a reflective phosphor plate mounted to a heatsink.

In some embodiments, the present invention provides fifth system having a scanned-light-beam apparatus that includes: a first laser that generates a first input laser beam; a first motor that has an axis of rotation; and a rotating mirror assembly driven by the first motor, wherein the rotating mirror assembly has a plurality of faces, each of which is at one selected angle of a plurality of different angles relative to the input laser beam, and wherein the first input laser beam is coupled to reflect from the rotating mirror assembly to form a plurality of scanned laser-beam lines parallel to one another.

In some embodiments of the fifth system, the rotating mirror assembly is a square mirror assembly.

In some embodiments of the fifth system, the rotating mirror assembly is of polygon shape other than a square.

Some embodiments of the fifth system further include a phosphor plate and a projection lens optically coupled such that the plurality of scanned laser-beam lines is directed toward the phosphor plate, and such that light emitted by the phosphor plate is projected by the projection lens. Some embodiments of the fifth system further include a vehicle, wherein the first laser emits a blue wavelength of light, wherein the first laser, the rotating mirror assembly, the phosphor plate and the projection lens are used to form a headlight beam for the vehicle.

In some embodiments, the present invention provides a first method for scanning a light beam. This first method includes: providing a first faceted optical device; rotating the first faceted optical device around a rotational axis; wherein the first faceted optical device has a plurality of faces, each of which is at one selected angle of a plurality of different angles relative to the rotational axis; generating a first light beam; and deflecting the first light beam toward the rotating first faceted optical device to form a first plurality of spaced-apart scanned light-beam lines. In some embodiments, the deflecting includes refracting the first light beam using a transparent prism. In other embodiments, the deflecting includes refracting the first light beam using a plurality of mirrors on the rotated first faceted optical device.

Some embodiments of the first method further include: providing a second multi-faceted mirror system that includes a second plurality of mirrors, wherein each one of the second plurality of mirrors is tilted at a different angle relative to the rotational axis; providing a third multi-faceted mirror system that includes a third plurality of mirrors, wherein each one of the third plurality of mirrors is tilted at a different angle relative to the rotational axis; providing a LiDAR receiver; providing a phosphor plate, wherein the first faceted optical device includes a first multi-faceted mirror system that includes a first plurality of mirrors, wherein each one of the first plurality of mirrors is tilted at a different angle relative to the rotational axis, and wherein the first light beam is a first input laser beam; directing the first input laser beam toward the first multi-faceted mirror system to form a first plurality of scanned laser-beam lines spaced apart from one another, and directing the first plurality of scanned laser-beam lines onto the phosphor plate such that the phosphor plate emits wavelength-converted light when stimulated by the first plurality of scanned laser-beam lines; projecting light emitted by the phosphor plate as an output vehicle headlight beam that includes the wavelength-converted light; rotating the second multi-faceted mirror system in synchrony with the first multi-faceted mirror system; directing a pulsed infrared (IR) laser beam toward the second multi-faceted mirror system to form a pattern of output light across a pattern of scanned directions spaced apart from one another to form a scanned pulsed output LiDAR beam; rotating the third multi-faceted mirror system in synchrony with the first multi-faceted mirror system; reflecting, with the third multi-faceted mirror system, a LiDAR light signal from the pattern of directions of the scanned pulsed output LiDAR beam into the LiDAR receiver; generating a LiDAR map based on the LiDAR light signal; and using the headlight beam, the pulsed LiDAR output beam and the LiDAR map for controlling a vehicle. In some such embodiments, the first input laser beam includes at least one wavelength in a range of 390 nm to 500 nm from a first laser and/or the pulsed infrared (IR) laser beam includes at least one wavelength in a range of 700 nm to 1500 nm from a pulsed IR laser.

In some embodiments of the first method, the first faceted optical device includes a square prism, and the first method further includes: tilting the square prism relative to the rotational axis such that a first pair of opposite faces is at a first angle to the rotational axis, and a second pair of opposite faces is at a second angle to the rotational axis, and the first angle is not equal to the second angle.

In some embodiments of the first method, the first faceted optical device includes a prism that has a plurality of pairs of parallel faces opposite each other relative to the rotational axis, wherein each pair of parallel faces is oriented at a different angle relative to the rotational axis.

In some embodiments of the first method, the first faceted optical device includes a multi-faceted mirror that includes a first plurality of mirrors, and the first method further includes: tilting each one of the first plurality of mirrors at a different angle relative to the rotational axis.

In some embodiments of the first method, the first light beam is a first input laser beam, and the first method further includes: deflecting the first input laser beam by the first faceted optical device to form a first plurality of scanned laser-beam lines spaced apart from one another; deflecting a second input laser beam by the first faceted optical device to form a second plurality of scanned laser-beam lines spaced apart from one another and from the first plurality of scanned laser-beam lines.

In some embodiments of the first method, the first light beam is a first input blue-light laser beam, and the first method further includes: deflecting the first input blue-light laser beam with first faceted optical device to form a first plurality of scanned blue-light laser-beam lines spaced apart from one another; providing a phosphor plate; directing the first plurality of scanned blue-light laser-beam lines onto the phosphor plate that emits wavelength-converted light when stimulated by the first plurality of scanned blue-light laser-beam lines; and projecting light emitted by the phosphor plate to form an output beam that includes the wavelength-converted light.

Some embodiments of the first method further include: providing a phosphor plate, wherein the first light beam is a first input laser beam that includes at least one wavelength (optionally in a range of 390 nm to 500 nm); deflecting the first input laser beam with the first faceted optical device to form a first plurality of scanned laser-beam lines spaced apart from one another onto the phosphor plate to emit wavelength-converted light when the phosphor plate is stimulated by the first plurality of scanned laser-beam lines; and projecting light emitted by the phosphor plate as an output headlight beam that includes the wavelength-converted light, wherein the headlight beam is for a vehicle.

In some embodiments of the first method, the first faceted optical device includes a first multi-faceted mirror system that includes a first plurality of mirrors, wherein each one of the first plurality of mirrors is tilted at a different angle relative to the rotational axis, and wherein the first light beam is a first input laser beam that includes at least one wavelength (optionally in a range of 390 nm to 500 nm), and the first method further includes: providing a phosphor plate; reflecting the first input laser beam using the first faceted optical device to form a first plurality of scanned laser-beam lines spaced apart from one another onto the phosphor plate such that the phosphor plate emits wavelength-converted light when stimulated by the first plurality of scanned laser-beam lines; and projecting light emitted by the phosphor plate as an output headlight beam for a vehicle.

In some embodiments of the first method, the first faceted optical device includes a first multi-faceted mirror system that includes a first plurality of mirrors, wherein each one of the first plurality of mirrors is tilted at a different angle relative to the rotational axis, wherein the first light beam is a first input infrared (IR) pulsed laser beam that includes at least one wavelength in a range of 700 nm to 1500 nm, wherein the method further includes reflecting the IR pulsed laser beam by the first faceted optical device to form a pattern of output light across a first plurality of scanned lines spaced apart from one another to form a scanned pulsed LiDAR output beam for a vehicle.

In some embodiments of the first method, the first faceted optical device includes a first multi-faceted mirror system that includes a first plurality of mirrors, wherein each one of the first plurality of mirrors is tilted at a different angle relative to the rotational axis, wherein the first light beam is a received LiDAR signal reflected, by an object, from a LiDAR beam that includes at least one wavelength in a range of 700 nm to 1500 nm, wherein the first method further includes reflecting light by the first faceted optical device from a pattern of scanned-line directions spaced apart from one another onto a LiDAR receiver from the pattern of scanned-line directions; and generating a LiDAR map for a vehicle based on signals from the LiDAR receiver.

In some embodiments of the first method, the first faceted optical device includes a square prism.

In some embodiments of the first method, the first faceted optical device includes a first square prism, wherein the first light beam is a first laser beam and the first method further includes: providing a second square prism; rotating the second square prism; and deflecting the first plurality of spaced-apart scanned light-beam lines from the first square prism by the second prism to form a second plurality of spaced-apart scanned laser-beam lines.

In some embodiments of the first method, the first faceted optical device includes a square polygon having four mirror faces.

In some embodiments of the first method, the first faceted optical device includes a square mirrored polygon having four mirror faces, wherein the first light beam is a first laser beam and the first method further includes: providing a second square mirrored polygon having four mirror faces; rotating the second square mirrored polygon; directing the first plurality of spaced-apart scanned light-beam lines reflected from the first square polygon towards the second square mirrored polygon; and reflecting the first plurality of spaced-apart scanned laser-beam lines with the second square mirrored polygon to form a second plurality of spaced-apart scanned laser-beam lines.

In some embodiments, the present invention provides a beam-splitter-based apparatus that forms two or more scanning beams per rotation, wherein the apparatus: a laser that generates a first laser beam; a first motor; a first rotating beam-splitter prism driven by the first motor, wherein the first rotating beam-splitter prism has a plurality of pairs of input/output faces and a first internal beam splitter structure, and wherein the input laser beam is coupled through the first rotating beam-splitter prism to form a first scanned laser-beam line when the first internal beam splitter structure is in a first orientation to the first laser beam, and to form a second scanned laser-beam line when the first internal beam splitter structure is in a second orientation to the first laser beam to form the two or more scanning beams per each rotation of the rotating beam-splitter prism.

In some embodiments of the beam-splitter-based apparatus, the first rotating beam-splitter prism has a square cross section, and wherein the first internal beam splitter structure extends diagonally between opposite corners of the square cross section. In some such embodiments, the first internal beam splitter structure is highly reflective to a wavelength of the first laser beam. In some such embodiments, the first internal beam splitter structure is partially reflective to a wavelength of the first laser beam. In some such embodiments, the first internal beam splitter structure is selectively reflective to a first polarization direction of the first laser beam. In some such embodiments, the first internal beam splitter structure is wavelength-selectively highly reflective to a wavelength of the first laser beam.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

1. (canceled)

2. The apparatus of claim 7,
wherein the first faceted optical device includes a first multi-faceted mirror system that includes a first plurality of mirrors, wherein each one of the first plurality of mirrors is tilted at a different angle relative to the rotational axis;
wherein the first light beam is a first input laser beam that is directed toward the first faceted optical device to form a first plurality of scanned laser-beam lines spaced apart from one another, and
wherein the apparatus further comprises:
a second multi-faceted mirror system that includes a second plurality of mirrors, wherein each one of the second plurality of mirrors is tilted at a different angle relative to the rotational axis, and wherein the second multi-faceted mirror system is rotated by the first motor;
a second laser that emits a pulsed infrared (IR) laser beam that is directed toward the second multi-faceted mirror system to form a pattern of output light across a pattern of scanned directions spaced apart from one another to form a scanned pulsed output LiDAR beam;
a third multi-faceted mirror system that includes a third plurality of mirrors, wherein each one of the third plurality of mirrors is tilted at a different angle relative to the rotational axis, wherein the third multi-faceted mirror system is rotated by the first motor, and wherein the third multi-faceted mirror system is configured to receive a LiDAR signal reflected from the pattern of directions of the scanned pulsed output LiDAR beam toward the third multi-faceted mirror system;
a LiDAR receiver operatively coupled to receive light reflected by the third multi-faceted mirror system from the pattern of scanned directions; and
a vehicle, wherein the first motor, the first laser, the first multi-faceted mirror system, the phosphor plate, the second laser, the second multi-faceted mirror system, the third multi-faceted mirror system and the LiDAR receiver are mounted to the vehicle and are used to form a headlight beam and the scanned pulsed LiDAR output beam for the vehicle.

3. The apparatus of claim 7, wherein the first faceted optical device includes a square prism that is tilted relative to the rotational axis such that a first pair of opposite faces is at a first angle to the rotational axis, and a second pair of opposite faces is at a second angle to the rotational axis, and the first angle is not equal to the second angle.

4. The apparatus of claim 7, wherein the first faceted optical device includes a prism that has a plurality of pairs of parallel faces opposite each other relative to the rotational axis, wherein each pair of parallel faces is oriented at a different angle relative to the rotational axis.

5. The apparatus of claim 7, wherein the first faceted optical device includes a multi-faceted mirror that includes a first plurality of mirrors, wherein each one of the first plurality of mirrors is tilted at a different angle relative to the rotational axis.

6. The apparatus of claim 7, wherein the first light beam is a first input laser beam directed toward the first faceted optical device to form a first plurality of scanned laser-beam lines spaced apart from one another, wherein the apparatus further comprises a second source of a second input laser beam directed toward the first faceted optical device, and wherein the second laser beam is coupled to the first faceted optical device to form a second plurality of scanned laser-beam lines spaced apart from one another and from the first plurality of scanned laser-beam lines.

7. A scanned-light-beam apparatus comprising:
a first source of a first light beam;
a first rotary motor that has a rotational axis; and
a first faceted optical device that is rotated around the rotational axis by the first motor,
wherein the first faceted optical device has a plurality of faces, each of which is at one selected angle of a plurality of different angles relative to the rotational axis,
wherein the first light beam is operatively coupled to the rotated first faceted optical device to form a first plurality of spaced-apart scanned light-beam lines, wherein the first light beam is a first input blue-light laser beam directed toward the first faceted optical device to form a first plurality of scanned blue-light laser-beam lines spaced apart from one another, and wherein the apparatus further comprises:
a phosphor plate operatively coupled to receive the first plurality of scanned blue-light laser-beam lines and to emit wavelength-converted light when stimulated by the first plurality of scanned blue-light laser-beam lines; and
a projection lens optically coupled to receive light emitted by the phosphor plate and to project an output beam that includes the wavelength-converted light.

8. The apparatus of claim 7, wherein the apparatus further comprises:
a vehicle, wherein the first motor, the first laser, the rotated first faceted optical device, the phosphor plate and the projection lens mounted to the vehicle and are used to form a headlight beam for the vehicle.

9. The apparatus of claim 7,
wherein the first faceted optical device includes a first multi-faceted mirror system that includes a first plurality of mirrors, wherein each one of the first plurality of mirrors is tilted at a different angle relative to the rotational axis, and
wherein the first light beam is a first input laser beam that includes at least one wavelength in a range of 390 nm to 500 nm from a first laser and that is directed toward the first faceted optical device to form a first plurality of scanned laser-beam lines spaced apart from one another.

10.-19. (canceled)

20. The apparatus of claim 40,
wherein the phosphor plate has a curved face configured such that the scanned laser-beam lines remain in focus across the curved face of the phosphor plate, and wherein the phosphor plate is a reflective phosphor plate mounted to a heatsink.

21. (canceled)

22. The method of claim 27, further comprising:
providing a second multi-faceted mirror system that includes a second plurality of mirrors, wherein each one of the second plurality of mirrors is tilted at a different angle relative to the rotational axis;
providing a third multi-faceted mirror system that includes a third plurality of mirrors, wherein each one of the third plurality of mirrors is tilted at a different angle relative to the rotational axis;
providing a LiDAR receiver;
providing a phosphor plate, wherein the first faceted optical device includes a first multi-faceted mirror system that includes a first plurality of mirrors, wherein each one of the first plurality of mirrors is tilted at a different angle relative to the rotational axis, and wherein the first light beam is a first input laser;
directing the first input laser beam toward the first multi-faceted mirror system to form a first plurality of scanned laser-beam lines spaced apart from one another, and directing the first plurality of scanned laser-beam lines onto the phosphor plate such that the phosphor plate emits wavelength-converted light when stimulated by the first plurality of scanned laser-beam lines;
projecting light emitted by the phosphor plate as an output vehicle headlight beam that includes the wavelength-converted light;
rotating the second multi-faceted mirror system in synchrony with the first multi-faceted mirror system;
directing a pulsed infrared (IR) laser beam toward the second multi-faceted mirror system to form a pattern of output light across a pattern of scanned directions spaced apart from one another to form a scanned pulsed output LiDAR beam;
rotating the third multi-faceted mirror system in synchrony with the first multi-faceted mirror system;
reflecting, with the third multi-faceted mirror system, a LiDAR light signal from the pattern of directions of the scanned pulsed output LiDAR beam into the LiDAR receiver;
generating a LiDAR map based on the LiDAR light signal; and
using the headlight beam, the pulsed LiDAR output beam and the LiDAR map for controlling a vehicle.

23. (canceled)

24. The method of claim 27, wherein the first faceted optical device includes a prism that has a plurality of pairs of parallel faces opposite each other relative to the rotational axis, wherein each pair of parallel faces is oriented at a different angle relative to the rotational axis.

25. The method of claim 27, wherein the first faceted optical device includes a multi-faceted mirror that includes a first plurality of mirrors, the method further comprising:
tilting each one of the first plurality of mirrors at a different angle relative to the rotational axis.

26. The method of claim 27, wherein the first light beam is a first input laser beam, the method further comprising:
deflecting the first input laser beam by the first faceted optical device to form a first plurality of scanned laser-beam lines spaced apart from one another;
deflecting a second input laser beam by the first faceted optical device to form a second plurality of scanned laser-beam lines spaced apart from one another and from the first plurality of scanned laser-beam lines.

27. A method for scanning a light beam, the method comprising:
providing a first faceted optical device;
rotating the first faceted optical device around a rotational axis; wherein the first faceted optical device has a plurality of faces, each of which is at one selected angle of a plurality of different angles relative to the rotational axis;
generating a first light beam; and
deflecting the first light beam with the rotating first faceted optical device to form a first plurality of spaced-apart scanned light-beam lines, wherein the first light beam is a first input blue-light laser beam;
deflecting the first input blue-light laser beam with first faceted optical device to form a first plurality of scanned blue-light laser-beam lines spaced apart from one another;
providing a phosphor plate;
directing the first plurality of scanned blue-light laser-beam lines onto the phosphor plate that emits wavelength-converted light when stimulated by the first plurality of scanned blue-light laser-beam lines; and
projecting light emitted by the phosphor plate to form an output beam that includes the wavelength-converted light.

28. The method of claim 27, further comprising:
providing a phosphor plate, wherein the first light beam is a first input laser beam that includes at least one wavelength in a range of 390 nm to 500 nm;
deflecting the first input laser beam with the first faceted optical device to form a first plurality of scanned laser-beam lines spaced apart from one another onto the phosphor plate to emit wavelength-converted light when the phosphor plate is stimulated by the first plurality of scanned laser-beam lines; and
projecting light emitted by the phosphor plate as an output headlight beam that includes the wavelength-converted light, wherein the headlight beam is for a vehicle.

29. The method of claim 27, wherein the first faceted optical device includes a first multi-faceted mirror system that includes a first plurality of mirrors, wherein each one of the first plurality of mirrors is tilted at a different angle relative to the rotational axis, and wherein the first light beam is a first input laser beam that includes at least one wavelength in a range of 390 nm to 500 nm, the method further comprising:
providing a phosphor plate;
reflecting the first input laser beam using the first faceted optical device to form a first plurality of scanned laser-beam lines spaced apart from one another onto the phosphor plate such that the phosphor plate emits wavelength-converted light when stimulated by the first plurality of scanned laser-beam lines; and
projecting light emitted by the phosphor plate as an output headlight beam for a vehicle.

30. The method of claim 27, wherein the first faceted optical device includes a first multi-faceted mirror system that includes a first plurality of mirrors, wherein each one of the first plurality of mirrors is tilted at a different angle relative to the rotational axis, wherein the first light beam is a first input infrared (IR) pulsed laser beam, wherein the method further includes:
reflecting the IR pulsed laser beam by the first faceted optical device to form a pattern of output light across a first plurality of scanned lines spaced apart from one another to form a scanned pulsed LiDAR output beam for a vehicle.

31. The method of claim 27, wherein the first faceted optical device includes a first multi-faceted mirror system that includes a first plurality of mirrors, wherein each one of the first plurality of mirrors is tilted at a different angle relative to the rotational axis, wherein the first light beam is a received LiDAR signal reflected, by an object, from a LiDAR beam, wherein the method further includes:
reflecting light by the first faceted optical device from a pattern of scanned-line directions spaced apart from one another onto a LiDAR receiver from the pattern of scanned-line directions; and
generating a LiDAR map for a vehicle based on signals from the LiDAR receiver.

32.-39. (canceled)

40. A scanning-beam apparatus comprising:
a first laser that generates a first input laser beam;
a first motor that has an axis of rotation; and
a rotating mirror assembly driven by the first motor, wherein the rotating mirror assembly has a plurality of faces, each of which is at one selected angle of a plurality of different angles relative to the input laser beam, and wherein the first input laser beam is coupled to reflect from the rotating mirror assembly to form a plurality of scanned laser-beam lines parallel to one another;
a phosphor plate and a projection lens optically coupled such that the plurality of scanned laser-beam lines is directed toward the phosphor plate, and such that light emitted by the phosphor plate is projected by the projection lens; and
a vehicle, wherein the first laser emits a blue wavelength of light, wherein the first laser, the rotating mirror assembly, the phosphor plate and the projection lens are used to form a headlight beam for the vehicle.

41.-46. (canceled)
